(19) United States
(12) Patent Application Publication
(10) Pub. No.: US 2025/0275637 A1
(43) Pub. Date: Sep. 4, 2025

(54) TELESCOPING RODS FOR USE WITH VANITY MIRRORS

(71) Applicant: Mirrorglow LLC, Austin, TX (US)

(72) Inventors: Glen Robert Boehm, Austin, TX (US); Kevin Keller, Austin, TX (US); Abhi Shah, Austin, TX (US)

(21) Appl. No.: 19/210,792

(22) Filed: May 16, 2025

Related U.S. Application Data
(63) Continuation of application No. PCT/US25/13266, filed on Jan. 27, 2025.
(63) Continuation-in-part of application No. 18/630,565, filed on Apr. 9, 2024, now Pat. No. 12,329,298.
Application No. 18/630,565 is a division of application No. 18/072,052, filed on Nov. 30, 2022, now Pat. No. 11,980,303.
Application No. 18/072,052 is a continuation of application No. 17/537,303, filed on Nov. 29, 2021, now Pat. No. 11,576,507.
Application No. 17/537,303 is a continuation-in-part of application No. 16/548,725, filed on Aug. 22, 2019, now Pat. No. 11,209,609.
(60) Provisional application No. 63/625,614, filed on Jan. 26, 2024.
(60) Provisional application No. 62/722,749, filed on Aug. 24, 2018.

(51) Int. Cl. A47G 1/17; A47G 1/00; A47G 1/02; G02B 7/198

(52) U.S. Cl. CPC A47G 1/17; A47G 1/02; G02B 7/198; A47G 2001/002; A47G 2200/08

(57) ABSTRACT

Telescoping rods including: a core tube having a first end and a second end; a first pulley mounted inside the core tube at the first end; a second pulley mounted inside the core tube at the second end; a belt mounted around and between the first pulley and the second pulley; a first arm coupled to the belt, partially located inside the core tube, and extending outward of the first end of the core tube; and a second arm coupled to the belt, partially located inside the core tube, and extending outward of the second end of the core tube. In some implementations, the belt contains teeth in an inside surface of the belt, the first pulley contains teeth that engage the teeth of the belt, and the second pulley contains teeth that engage the belt.

### CROSS-REFERENCE TO RELATED APPLICATIONS

This application: is a continuation of International Patent Application No. PCT/US2025/013266, filed Jan. 27, 2025, which claims the benefit of U.S. Provisional Patent Application No. 63/625,614, filed Jan. 26, 2024; and is a continuation-in-part of U.S. patent application Ser. No. 18/630,565, filed Apr. 9, 2024, which is a divisional of U.S. patent application Ser. No. 18/072,052, filed Nov. 30, 2022, now U.S. Pat. No. 11,980,303, which is a continuation of U.S. patent application Ser. No. 17/537,303, filed Nov. 29, 2021, now U.S. Pat. No. 11,576,507, which is a continuation-in-part of U.S. patent application Ser. No. 16/548,725, filed Aug. 22, 2019, now U.S. Pat. No. 11,209,609, and which claims the benefit of U.S. Provisional Application No. 62/722,749, filed on Aug. 24, 2018, each of which is hereby incorporated by reference herein in their entireties.

### TECHNICAL FIELD

The present disclosure relates generally to vanity mirrors.

### BACKGROUND

Vanity mirrors are reflective devices that are typically used for personal grooming, shaving, applying makeup, or the like.

Vanity mirrors are available in various configurations, including wall-mounted, free-standing, and hand-held. A common problem, however, with each of these configurations is that users of the mirror must reposition themselves to obtain the desired distance from the reflective surface and the requisite height for the reflective surface to be viewable. This repositioning is particularly undesirable when the user is required to bend over to reach the desired height and distance, which may cause back and neck pain. In the case of a hand-held mirror, the user may be able to reposition the mirror but must hold the mirror at the desired location, thereby reducing their ability to perform the required grooming tasks.

Accordingly, new adjustable vanity mirrors are desirable.

### SUMMARY

In accordance with some embodiments, telescoping rods for use with vanity mirrors are provided.

In some embodiments, telescoping rods are provided, the telescoping rods comprising: a core tube having a first end and a second end; a first pulley mounted inside the core tube at the first end; a second pulley mounted inside the core tube at the second end; a belt mounted around and between the first pulley and the second pulley; a first arm coupled to the belt, partially located inside the core tube, and extending outward of the first end of the core tube; and a second arm coupled to the belt, partially located inside the core tube, and extending outward of the second end of the core tube.

In some of these embodiments, the belt contains teeth in an inside surface of the belt, the first pulley contains teeth that engage the teeth of the belt, and the second pulley contains teeth that engage the belt.

In some of these embodiments, the telescoping rods further comprise a first clamp that couples the belt to the first arm and a second clamp that couples the belt to the second arm.

In some of these embodiments, the telescoping rods further comprise a middle tube that contains the core tube, wherein the middle tube has a first end and a second end.

In some of these embodiments, the telescoping rods further comprise a cable positioned between to core tube and the middle tube.

In some of these embodiments, the telescoping rods further comprise a top tube that at least partially fits inside the middle tube, extends outward from the middle tube at the first end of the middle tube, and is coupled to the first arm.

In some of these embodiments, the telescoping rods further comprise first bushing located on an outside surface of the top tube at the second end of the top tube.

In some of these embodiments, the first bushing comprises two parts.

In some of these embodiments, a middle portion of the first bushing has a larger diameter than another portion of the first bushing.

In some of these embodiments, the telescoping rods further comprise a second bushing located at the first end of the middle tube between the top tube and the middle tube.

In some of these embodiments, the second bushing includes at least one raised surface that presses on an inside surface of the middle tube and cause a portion of the second bushing to bend and apply pressure to an outside surface of the top tube.

In some of these embodiments, the telescoping rods further comprise a top cap that couples the first arm and the top tube to a mirror.

In some of these embodiments, the telescoping rods further comprise a bottom tube that at least partially extends over the middle tube, extends away from the middle tube at the second end of the middle tube, and is coupled to the second arm.

In some of these embodiments, the telescoping rods further comprise a third bushing located at a first end of the bottom tube between the bottom tube and the middle tube.

In some of these embodiments, the third bushing includes at least one raised surface that presses on an inside surface of the bottom tube and cause a portion of the third bushing to bend and apply pressure to an outside surface of the middle tube.

In some of these embodiments, the telescoping rods further comprise a pad coupled to the middle tube that presses on the bottom tube to slow movement between the middle tube and the bottom tube.

In some of these embodiments, the pad is longer in a first dimension along the axis of the middle tube than it is wide in a second dimension that is perpendicular to the first dimension.

In some of these embodiments, the telescoping rods further comprise a bottom cap that couples the second arm and the bottom tube to a base.

### BRIEF DESCRIPTION OF THE DRAWINGS

FIG. 1 illustrates a front view of an example of a mirror assembly with the telescoping rod extended and trigger arm engaged in accordance with some embodiments.

FIG. 2 illustrates a front perspective view of an example of a mirror assembly with the telescoping rod extended, trigger arm engaged, and hanger bracket retracted in accordance with some embodiments.

FIG. 3 illustrates a rear view of an example of a mirror assembly with the telescoping rod extended and hanger bracket retracted in accordance with some embodiments.

FIG. 4 illustrates a rear perspective view of an example of a mirror assembly with the telescoping rod extended, trigger arm engaged, and hanger bracket retracted in accordance with some embodiments.

FIG. 5 illustrates a side view of an example of a mirror assembly with the telescoping rod extended, trigger arm engaged, and hanger bracket retracted in accordance with some embodiments.

FIG. 6 illustrates a front view of an example of a mirror assembly with the telescoping rod retracted and trigger arm disengaged in accordance with some embodiments.

FIG. 7 illustrates a front perspective view of an example of a mirror assembly with the telescoping rod retracted, trigger arm disengaged, and hanger bracket retracted in accordance with some embodiments.

FIG. 8 illustrates a rear perspective view of an example of a mirror assembly with the telescoping rod retracted, trigger arm disengaged, and hanger bracket retracted in accordance with some embodiments.

FIG. 9 illustrates a front perspective view of an example of a mirror assembly with the telescoping rod retracted, trigger arm engaged, hanger bracket extended, and reflective surfaces partially rotated in accordance with some embodiments.

FIG. 10 illustrates a rear perspective view of an example of a mirror assembly with the telescoping rod retracted, trigger arm engaged, hanger bracket extended, and reflective surfaces partially rotated in accordance with some embodiments.

FIG. 11A illustrates a front view of an example of a mirror assembly with the hanger bracket extended and engaged over a door or ledge in accordance with some embodiments.

FIG. 11B illustrates a front view of an example of a mirror assembly with the hanger bracket extended and engaged over a door or ledge in accordance with some embodiments.

FIG. 12A illustrates a bottom perspective view of an example of a mirror assembly with the hanger bracket extended and engaged over a door or ledge in accordance with some embodiments.

FIG. 12B illustrates a bottom perspective view of an example of a mirror assembly with the hanger bracket extended and engaged over a door or ledge in accordance with some embodiments.

FIG. 13A illustrates a front perspective view of an example of a mirror assembly with the hanger bracket extended and engaged over a door or ledge in accordance with some embodiments.

FIG. 13B illustrates a front perspective view of an example of a mirror assembly with the hanger bracket extended and engaged over a door or ledge in accordance with some embodiments.

FIG. 14 illustrates a front view of an example of a mirror assembly with the telescoping rod retracted, trigger arm disengaged, and reflective surfaces partially rotated in accordance with some embodiments.

FIG. 15 illustrates a front perspective view of an example of a mirror assembly with the telescoping rod retracted, trigger arm disengaged, hanger bracket retracted, and reflective surfaces partially rotated in accordance with some embodiments.

FIG. 16 illustrates a front perspective view of an example of a mirror assembly with the telescoping rod retracted, trigger arm engaged, hanger bracket retracted, and reflective surfaces partially rotated in accordance with some embodiments.

FIG. 17 illustrates a rear perspective view of an example of a mirror assembly with the telescoping rod retracted, trigger arm disengaged, hanger bracket retracted, and reflective surfaces partially rotated in accordance with some embodiments.

FIG. 18 illustrates a side view of an example of a mirror assembly with the telescoping rod retracted, trigger arm disengaged, hanger bracket retracted, and reflective surfaces partially rotated in accordance with some embodiments.

FIG. 19 illustrates a front view of an example of a mirror assembly with the telescoping rod extended and trigger arm engaged in accordance with some embodiments.

FIG. 20 illustrates a front perspective view of an example of a mirror assembly with the telescoping rod extended, trigger arm engaged, and hanger bracket retracted in accordance with some embodiments.

FIG. 21 illustrates a rear view of an example of a mirror assembly with the telescoping rod extended and hanger bracket retracted in accordance with some embodiments.

FIG. 22 illustrates a rear perspective view of an example of a mirror assembly with the telescoping rod extended, trigger arm engaged, and hanger bracket retracted in accordance with some embodiments.

FIG. 23 illustrates a side view of an example of a mirror assembly with the telescoping rod extended, trigger arm engaged, and hanger bracket retracted in accordance with some embodiments.

FIG. 24 illustrates a front view of an example of a mirror assembly with the telescoping rod retracted and trigger arm disengaged in accordance with some embodiments.

FIG. 25 illustrates a front perspective view of an example of a mirror assembly with the telescoping rod retracted, trigger arm disengaged, and hanger bracket retracted in accordance with some embodiments.

FIG. 26 illustrates a rear perspective view of an example of a mirror assembly with the telescoping rod retracted, trigger arm disengaged, and hanger bracket retracted in accordance with some embodiments.

FIG. 27 illustrates a front perspective view of an example of a mirror assembly with the telescoping rod retracted, trigger arm engaged, hanger bracket extended, and reflective surfaces partially rotated in accordance with some embodiments.

FIG. 28 illustrates a rear perspective view of an example of a mirror assembly with the telescoping rod retracted, trigger arm engaged, hanger bracket extended, and reflective surfaces partially rotated in accordance with some embodiments.

FIG. 29A illustrates a front view of an example of a mirror assembly with the hanger bracket extended and engaged over a door or ledge in accordance with some embodiments.

FIG. 29B illustrates a front view of an example of a mirror assembly with the hanger bracket extended and engaged over a door or ledge in accordance with some embodiments.

FIG. 30A illustrates a bottom perspective view of an example of a mirror assembly with the hanger bracket extended and engaged over a door or ledge in accordance with some embodiments.

FIG. 30B illustrates a bottom perspective view of an example of a mirror assembly with the hanger bracket extended and engaged over a door or ledge in accordance with some embodiments.

FIG. 31A illustrates a front perspective view of an example of a mirror assembly with the hanger bracket extended and engaged over a door or ledge in accordance with some embodiments.

FIG. 31B illustrates a front perspective view of an example of a mirror assembly with the hanger bracket extended and engaged over a door or ledge in accordance with some embodiments.

FIG. 32 illustrates a front view of an example of a mirror assembly with the telescoping rod retracted, trigger arm disengaged, and reflective surfaces partially rotated in accordance with some embodiments.

FIG. 33 illustrates a front perspective view of an example of a mirror assembly with the telescoping rod retracted, trigger arm disengaged, hanger bracket retracted, and reflective surfaces partially rotated in accordance with some embodiments.

FIG. 34 illustrates a front perspective view of an example of a mirror assembly with the telescoping rod retracted, trigger arm engaged, hanger bracket retracted, and reflective surfaces partially rotated in accordance with some embodiments.

FIG. 35 illustrates a rear perspective view of an example of a mirror assembly with the telescoping rod retracted, trigger arm disengaged, hanger bracket retracted, and reflective surfaces partially rotated in accordance with some embodiments.

FIG. 36 illustrates a side view of an example of a mirror assembly with the telescoping rod retracted, trigger arm disengaged, hanger bracket retracted, and reflective surfaces partially rotated in accordance with some embodiments.

FIG. 37 illustrates a front view of an example of a mirror assembly with the telescoping rod retracted, trigger arm engaged, hanger bracket retracted, and housing rotated in accordance with some embodiments.

FIG. 38 illustrates a side view of an example of a mirror assembly with the telescoping rod retracted, trigger arm engaged, hanger bracket retracted, and housing rotated in accordance with some embodiments.

FIG. 39 illustrates a front perspective view of an example of a mirror assembly with the telescoping rod retracted, trigger arm engaged, hanger bracket retracted, and housing rotated in accordance with some embodiments.

FIG. 40 illustrates an example of a core telescope assembly, including an upper arm, two pulleys, a belt, two clamps, and a lower arm, of a telescoping rod in accordance with some embodiments.

FIG. 41 illustrates an example of an upper arm of a telescoping rod in accordance with some embodiments.

FIG. 42 illustrates an example of a belt of a telescoping rod in accordance with some embodiments.

FIG. 43 illustrates an example of a clamp of a telescoping rod in accordance with some embodiments.

FIG. 44 illustrates an example of a pulley of a telescoping rod in accordance with some embodiments.

FIG. 45 illustrates an example of a lower arm of a telescoping rod in accordance with some embodiments.

FIG. 46 illustrates an example of core tube over the components of FIG. 40 in accordance with some embodiments.

FIG. 47 illustrates an example of a core tube in accordance with some embodiments.

FIG. 48 illustrates an example of the components of FIG. 46 with the addition of a first end cap in accordance with some embodiments.

FIG. 49 illustrates an example of the first end cap of FIG. 48 in accordance with some embodiments.

FIG. 50 illustrates an example of the components of FIG. 48 with the addition of a cable in accordance with some embodiments.

FIG. 51 illustrates an example of the components of FIG. 50 inside a middle tube in accordance with some embodiments.

FIG. 52 illustrates an example of the middle tube of FIG. 51 in accordance with some embodiments.

FIG. 53 illustrates an example of the components of FIG. 51 with a top tube in accordance with some embodiments.

FIG. 54 illustrates an example of the top tube in accordance with some embodiments.

FIG. 55 illustrates an example of the top tube with a first bushing in accordance with some embodiments.

FIG. 56 illustrates an example of the first bushing in accordance with some embodiments.

FIG. 57 illustrates an example of the components of FIG. 55 along with a second bushing in accordance with some embodiments.

FIG. 58 illustrates an example of the second bushing in accordance with some embodiments.

FIG. 59 illustrates an example of the components of FIG. 57 along with a third bushing in accordance with some embodiments.

FIG. 60 illustrates an example of the third bushing in accordance with some embodiments.

FIG. 61 illustrates an example of a friction pad in accordance with some embodiments.

FIG. 62 illustrates an example of the friction pad in accordance with some embodiments.

FIG. 63 illustrates an example of a top tube, a middle tube, and a bottom tube of a telescoping rod in accordance with some embodiments.

FIG. 64 illustrates an example of the bottom tube in accordance with some embodiments.

FIG. 65 illustrates an example of the top tube, the middle tube, and the bottom tube along with a second end cap in accordance with some embodiments.

FIG. 66 illustrates an example of the second end cap in accordance with some embodiments.

FIG. 67 illustrates an example of the top tube, the middle tube, and the bottom tube along with a third end cap in accordance with some embodiments.

FIG. 68 illustrates an example of the third end cap in accordance with some embodiments.

FIG. 69 illustrates an example of a suction cup having a suction release mechanism in accordance with some embodiments.

FIG. 70 illustrates an example of a pulley of a telescoping rod have a groove for an o-ring along with an o-ring and bumps on an adjacent rod in accordance with some embodiments.

FIG. 71 illustrates an example of a bushing as shown in FIG. 60 inside a tube in accordance with some embodiments.

FIG. 72 illustrates an example of a modified bushing of FIG. 56 in accordance with some embodiments.

### DETAILED DESCRIPTION

In accordance with some embodiments, adjustable vanity mirrors are provided.

In some embodiments, a mirror assembly comprising a mirror, suction cup base with a hanger bracket, swivel joint, adjustable telescoping rod, and light source with diffuser screen is provided.

In some embodiments, a hands-free, adjustable telescoping magnifying mirror with a swivel joint, adjustable telescoping rod, and light source with diffuser screen is provided. The mirror can be secured to a horizontal or vertical surface using a suction cup base or can be hung over a door or ledge using a retractable hanger bracket, in some embodiments. In some embodiments, a telescoping rod is attached to the suction cup base. The mirror can be extended from the base by extending the telescoping rod and the mirror assembly can stand freely without falling over, whether the suction cup base is engaged or not, in some embodiments. In some embodiments, the telescoping rod can have a base stage and four additional stages, wherein the base stage has a certain diameter, stages one and two have progressively decreasing diameters, and stages three and four have progressively increasing diameters such that the diameter of stage four can be equal to the diameter of the base stage. In some embodiments, this multi-stage configuration permits the use of a larger connection point for attachment of a joint, such as a swivel joint, to secure the telescoping rod to the mirror housing, thereby increasing the stability and strength of the joint while also allowing stage four of the telescoping rod to cover the joint, thereby additionally providing aesthetic benefits. A smooth disc can also be supplied to increase stability of the mirror assembly by removably mounting the suction cup base to the disc, giving the base a larger footprint, in some embodiments.

In some embodiments, the swivel joint provides several advantages, including increased repositionability and increased portability and convenience. Additionally, in some embodiments, the light source with diffuser screen provides several advantages, including providing a uniform light glow and automatic deactivation when the mirror assembly is using battery power.

In some embodiments, the mirror assembly has a first reflective surface disposed on a first side of the mirror and second reflective surface disposed on a second side of the mirror. The first reflective surface and second reflective surface can be magnifying or non-magnifying and can have different levels of magnification than one another, in some embodiments. The mirror can also have a lever that when triggered rotates the first reflective surface and second reflective surface relative to light source or sources about an axis normal to the vertical axis of the telescoping rod, for example, thereby allowing a user to view the reflective surface that provides the desired magnification level, in some embodiments. In some embodiments, the mirror can include a clamp brake that adds friction to the rotation of the first and second reflective surfaces, thereby enhancing the user's ability to make back-and-forth adjustments to the position of the reflective surfaces and increasing the ability of the first and second reflective surfaces to remain in the desired position.

In some embodiments, mirrors as described herein solve one or more problems of prior mirrors by providing a hands-free, adjustable mirror assembly with a suction cup base, hanger bracket, swivel joint, telescoping rod, and light source with diffuser screen. In some embodiments, the suction cup base allows the user to position the mirror assembly at the desired distance, height, and angle from the user while maintaining the stability of the mirror assembly. In some embodiments, the swivel joint allows the user to rotate the mirror about the axis of the swivel joint, thereby allowing a user of the mirror to achieve the desired mirror position in relation to the position of the user. For example, in some embodiments, if a user is seated while using the mirror, the swivel joint allows the user to rotate the mirror to a height that permits the user to more comfortably view the mirror at the angle desired by the user. The swivel joint can be operated by, for example, rotating the mirror about the axis of the swivel joint, in some embodiments. The swivel joint also permits a user to adjust the position of the mirror in a one-step process that does not require the user to fold the mirror such that the light source no longer faces the user. In some embodiments, the swivel joint can include a spring-loaded pin mechanism that permits the user to lock the mirror in the desired position. In some embodiments, the swivel joint also permits a user to rotate the mirror housing for more compact storage and transport of the mirror assembly, thereby increasing portability and convenience, in some embodiments. In some embodiments, the light source can include a diffuser screen to diffuse light emitted by the light source thereby providing a uniform light glow. In some embodiments, the light source can automatically deactivate after a certain period of time, for example, 20 minutes, thereby conserving battery power when the mirror assembly is not plugged in to an electrical outlet. In some embodiments, when the light source is set to the user's desired dimmer setting and the light source is deactivated and later reactivated, the light source will return to the previous dimmer setting. In some embodiments, the hanger bracket permits the user to hang the mirror assembly at the desired height and position over a door or ledge while maintaining the stability of the mirror assembly. These features of some embodiments permit a user of the corresponding embodiments to stand or sit, as desired, and permit the user to move the mirror assembly to the desired location rather than bending over to reach the desired distance from the reflective surface, thereby potentially avoiding causing back and neck pain. The ability to hang the present mirror assembly over a door or ledge also provides the user with the ability to utilize the mirror assembly in a variety of locations, in some embodiments.

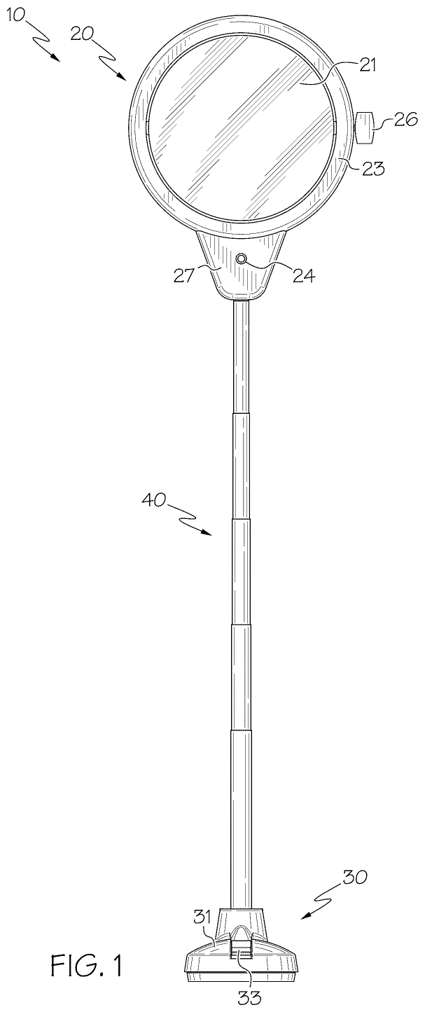

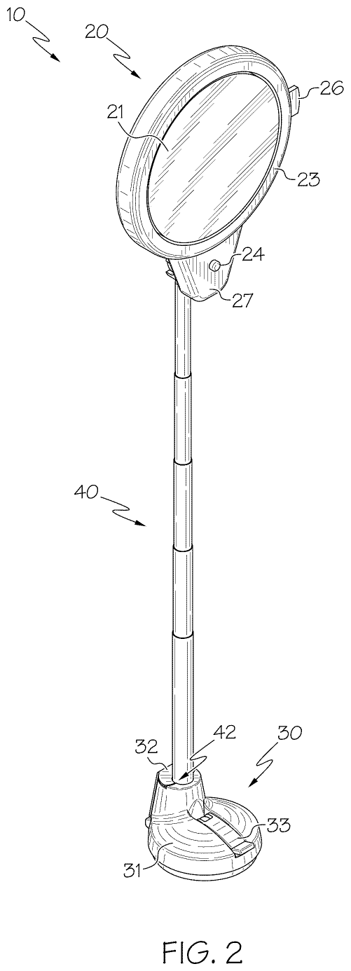

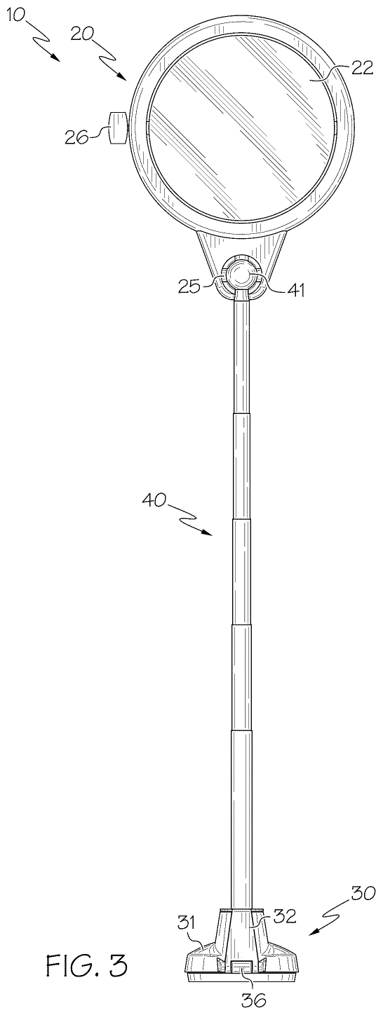

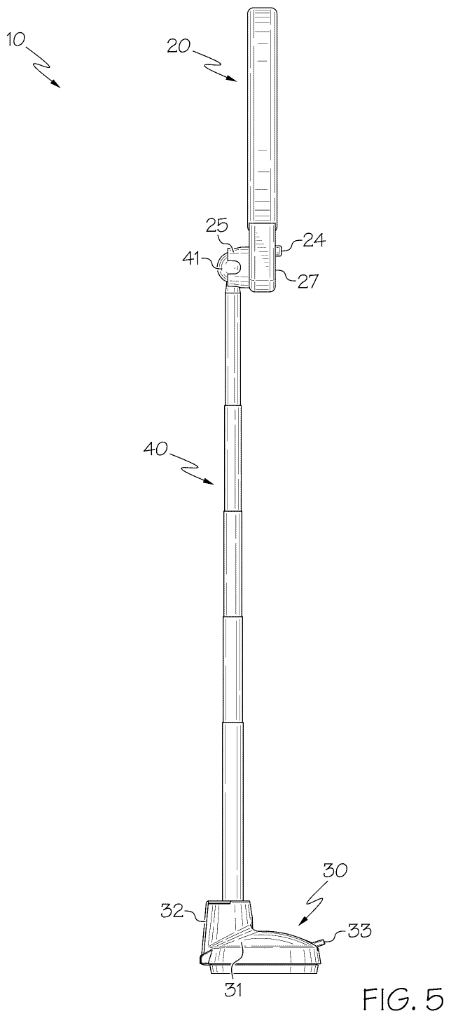

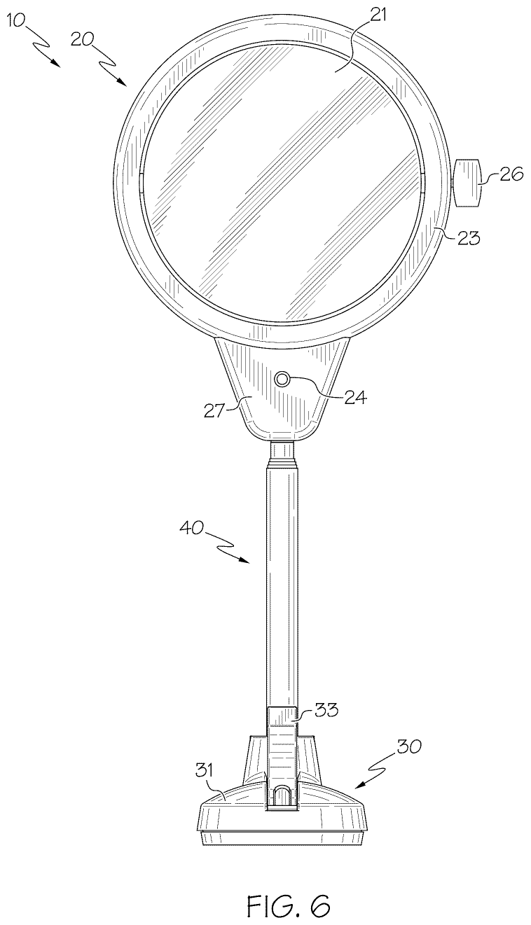

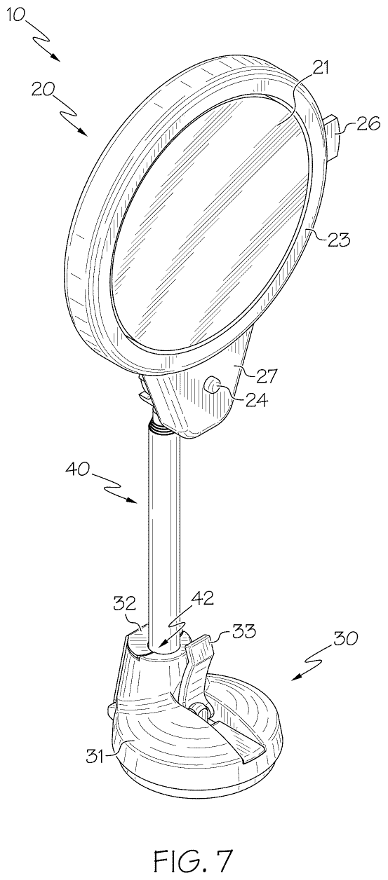

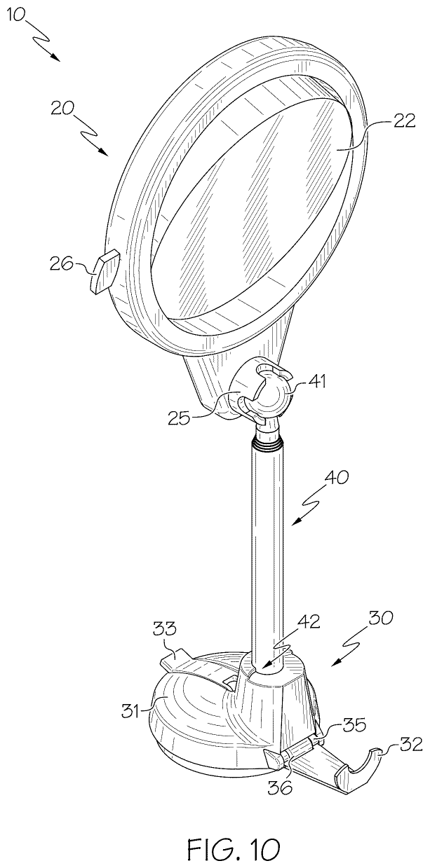

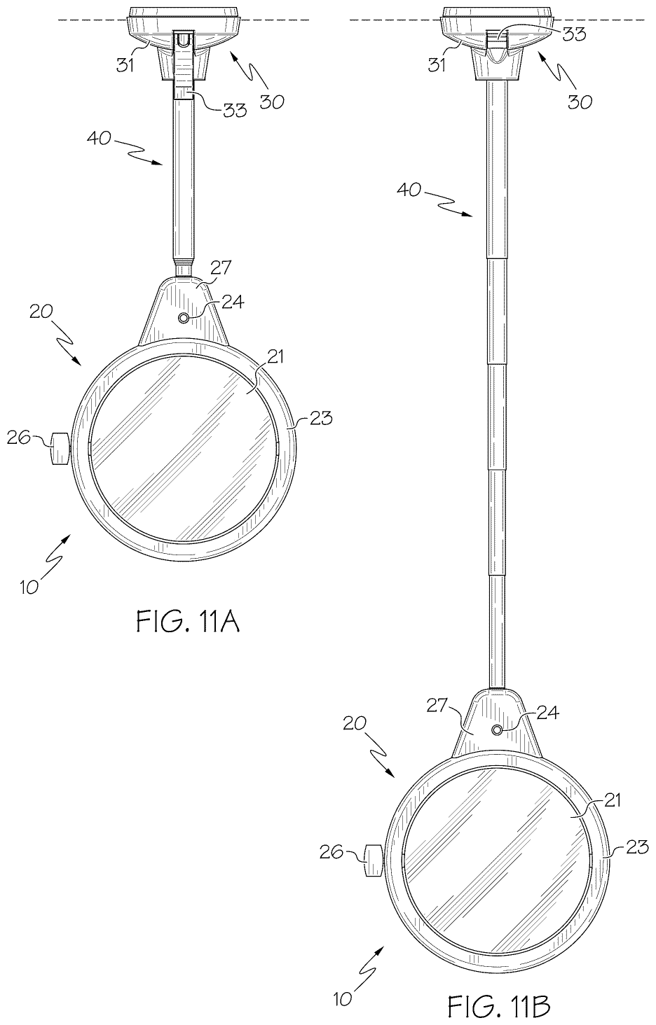

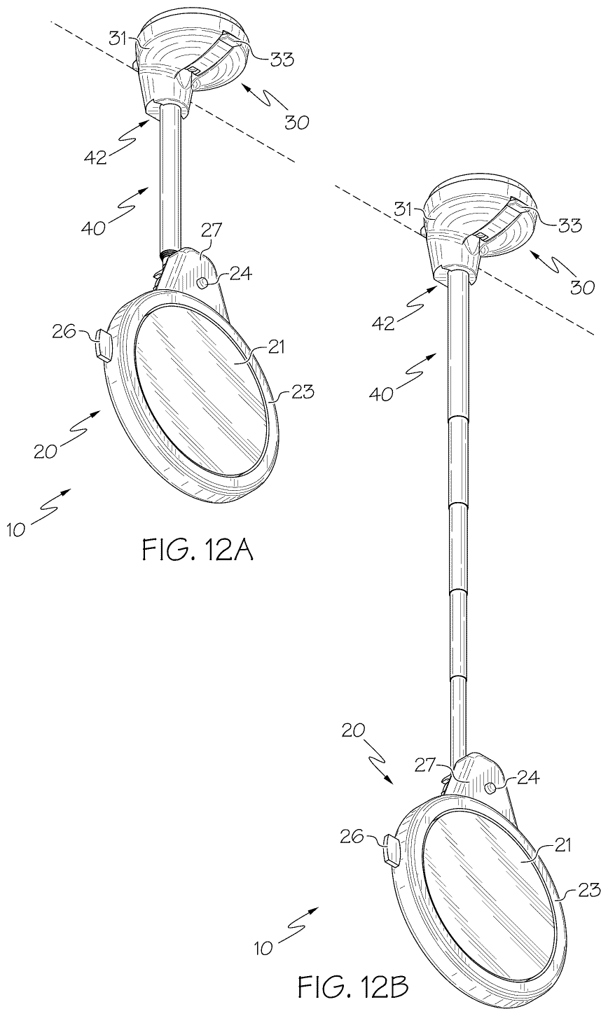

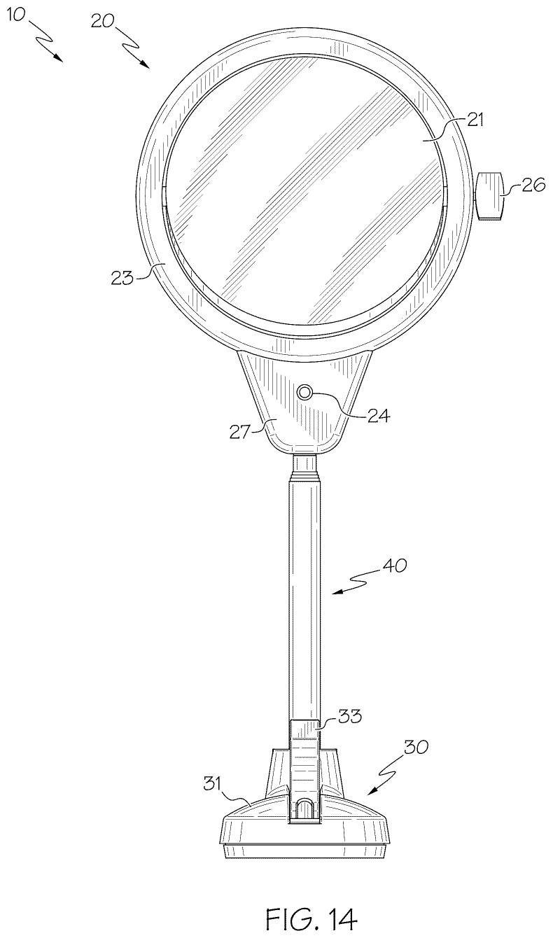

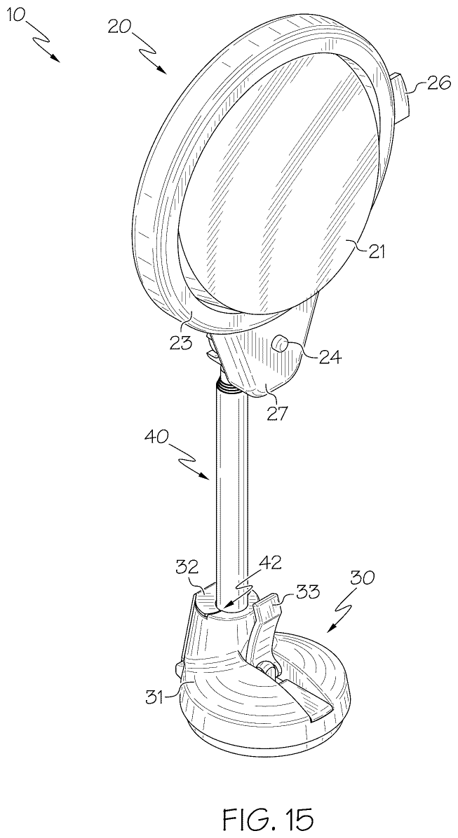

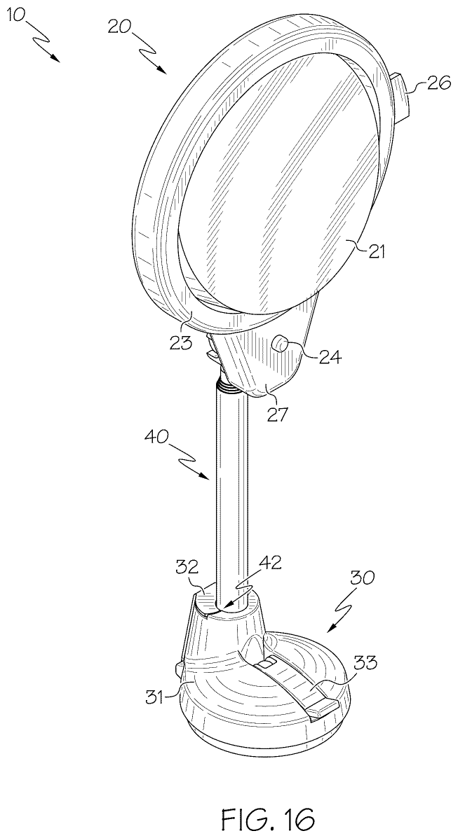

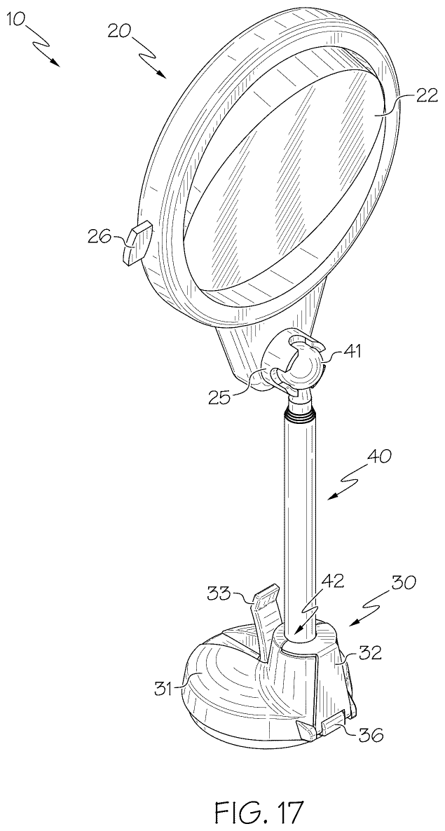

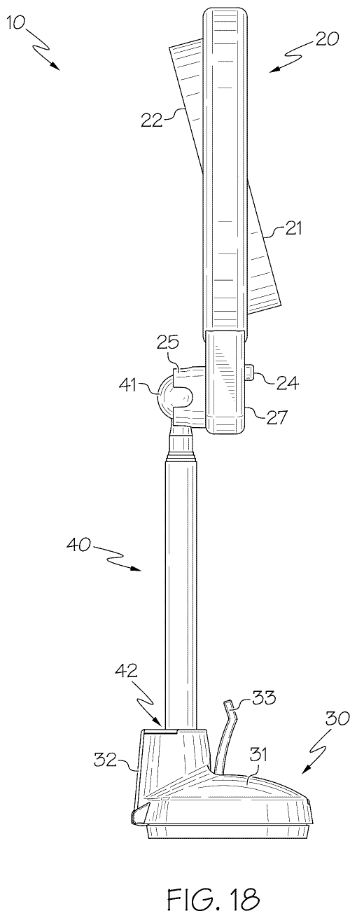

FIGS. 1-18 illustrate mirror assemblies in accordance with some embodiments. In some embodiments, a mirror assembly 10 comprises a mirror 20, a suction cup base assembly 30, and a telescoping rod 40. Mirror 20 can have a first reflective surface 21 on a first side and a second reflective surface 22 on a second side, in some embodiments. In some embodiments, there can be one or more light sources 23 disposed at a periphery of first reflective surface 21 or second reflective surface 22. The light source or sources 23 can be powered by a battery (e.g., a rechargeable battery) or can be plugged into an electrical outlet, for example. The light source or sources 23 can be activated and deactivated by a switch 24, or the like, which can be located adjacent the light source 23 on the front side of housing 27, on the reverse side of housing 27, or in the suction cup base assembly 30, for example. Switch 24 can be a push-button toggle switch, for example, or can be a rotatable knob that allows a user to adjust the intensity of light emitted by light source 23 by rotating the knob in a clockwise or counterclockwise direction. Housing 27 can have a socket for use in a ball joint by which a first end 41 of telescoping rod 40 can be secured to housing 27. The mirror 20 can also have a lever 26 that when triggered rotates reflective surfaces 21 and 22 relative to light source or sources 23 about an axis normal to the vertical axis of telescoping rod 40, for example, thereby allowing a user to view the reflective surface that provides the desired magnification level. In some embodiments, other methods and axes of rotation can be used to rotate reflective surfaces 21 and 22. Each reflective surface 21 and 22 can be non-magnifying or can be magnifying, and each can provide level a of magnification of, for example, 1×, 3×, 5×, 7×, 10×, 15×, or 20×.

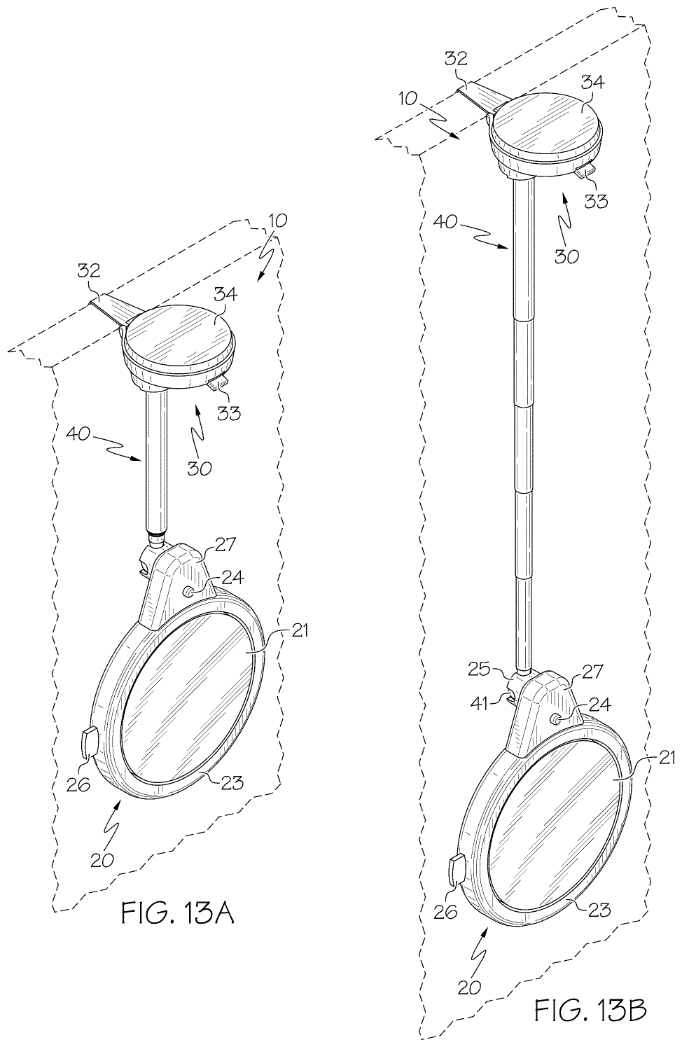

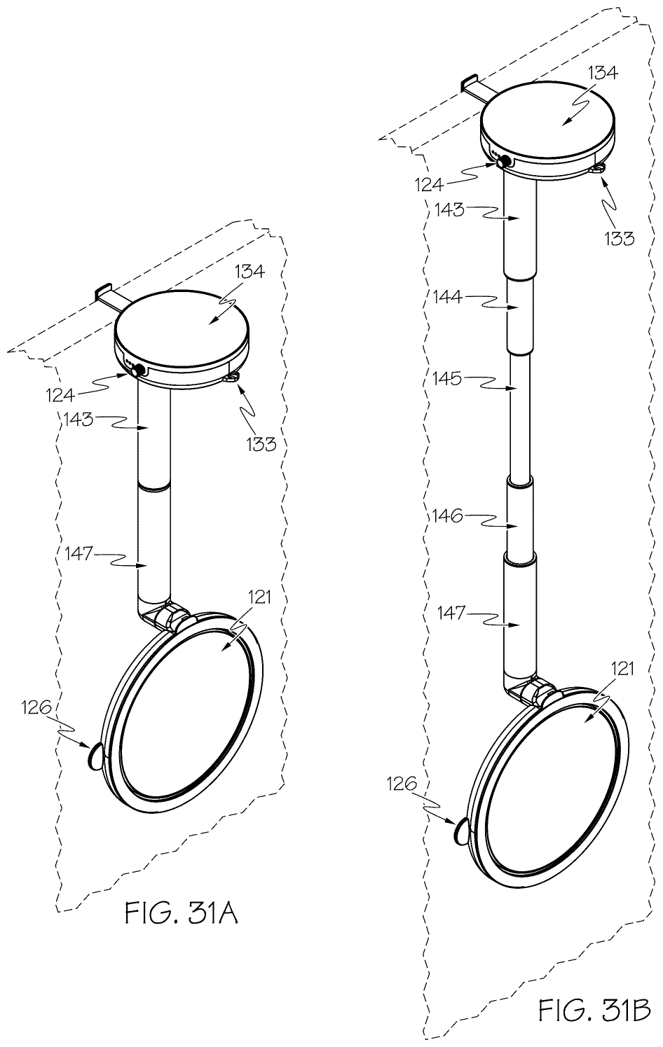

In some embodiments, suction cup base assembly 30 is substantially hemispherical in shape, comprising a round, flexible, concave diaphragm 34 (i.e., a suction cup) on the front side of the planar surface of the hemisphere, as illustrated in FIGS. 13A, 13B, 31A, and 31B. In some embodiments, the suction cup base assembly 30 can comprise any suitable number of suction cups. In some embodiments, the suction cup base assembly 30 comprises only one suction cup 34 in order to reduce the size and weight of the mirror assembly 10, thereby increasing portability. The suction cup 34 can be used to removably mount the mirror assembly 10 to a horizontal or vertical surface, in some embodiments. In some embodiments, the suction cup 34 can be a locking suction cup or a non-locking suction cup. In some embodiments, a housing portion 31 is disposed on the reverse side of the planar surface of the hemisphere. The housing portion 31 can be made of any suitable material, such as a water-, abrasion-, and stain-resistant material, such as plastic, in some embodiments. In some embodiments, a material such as plastic will resist discoloration and rust that can occur due to conditions in which the mirror assembly can be utilized, e.g., in a damp environment such as a bathroom, adjacent to a water source such as a sink, or near substances that can stain or discolor such as makeup or other grooming products. In some embodiments, the plastic material from which the housing portion 31 of the suction cup base assembly 30 is preferably comprised can also be flexible such that it will not crack or break if the mirror assembly 10 is dropped. If the suction cup 34 is a locking suction cup, the housing portion 31 of the suction cup base assembly 30 can also include a trigger arm 33 for engaging the suction cup 34 such that it becomes removably mounted to a horizontal or vertical surface, in some embodiments. The trigger arm 33 can be comprised of any suitable material, in some embodiments. In some embodiments, due to the conditions in which the mirror assembly 10 can be utilized, e.g., in a damp environment such as a bathroom, or adjacent to a water source such as a sink, the trigger arm 33 can be selected to be comprised of a water- and rust-resistant material such as stainless steel or aluminum.

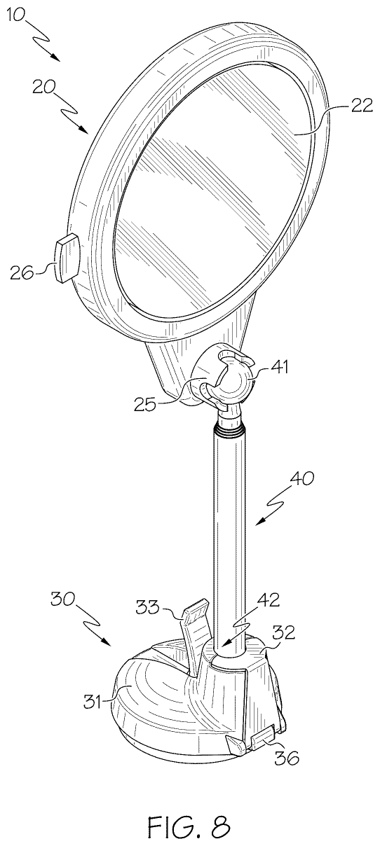

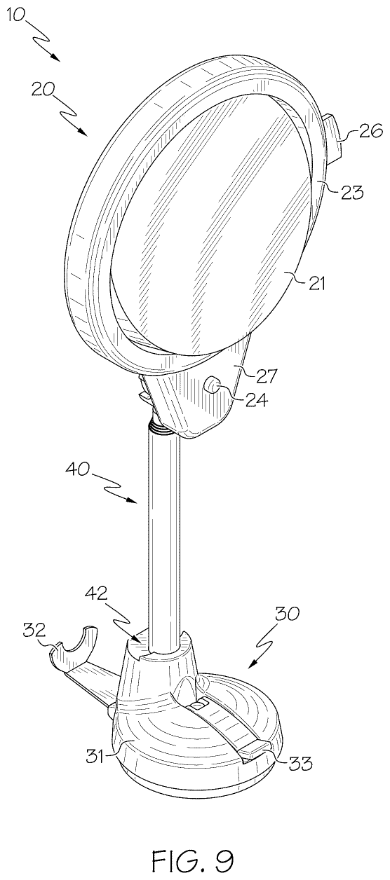

In some embodiments, the suction cup base assembly 30 can also include a hanger bracket 32. The hanger bracket 32 can provide support for the mirror assembly 10 to be hung in an inverted manner on a door, a ledge, or the like, in some embodiments. To permit the mirror assembly 10 to be hung in an inverted manner from a door, ledge, or the like, the hanger bracket 32 can have an internal dimension sufficient to accommodate the minimum and maximum standard thickness of an interior door, in some embodiments. The hanger bracket 32 can be shaped as shown, for example, in FIGS. 9, 10, 13A, 13B, or can be shaped in any manner suitable to allow it to support the mirror assembly 10 over a door, ledge, or the like, in some embodiments. The hanger bracket 32 can be made of any suitable material, such metal (e.g., stainless steel) so that it can adequately support the mirror assembly 10 and is thin enough to permit the door on which the mirror assembly 10 can be hung to be closed, in some embodiments. In some embodiments, due to the conditions in which the mirror assembly 10 can be utilized, e.g., in a damp environment such as a bathroom, or adjacent to a water source such as a sink, the hanger bracket 32 can be comprised of a water- and rust-resistant material such as stainless steel.

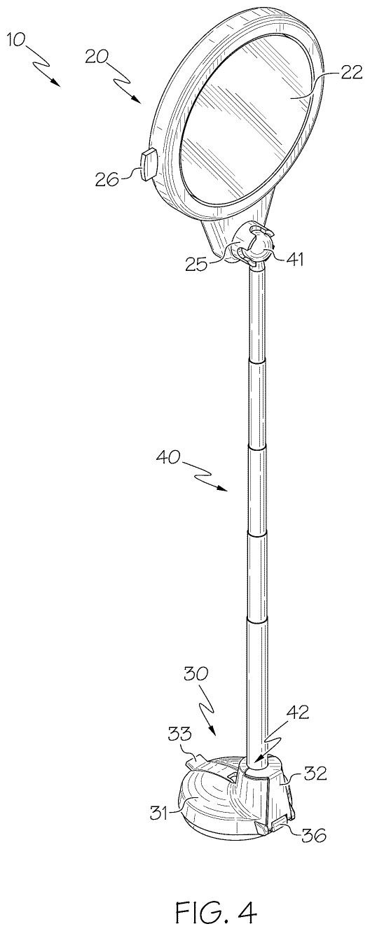

In some embodiments, the hanger bracket 32 can be secured to hinge plate 36 of the suction cup base assembly 30 using a hinge assembly 35. The hinge assembly 35 permits the hanger bracket 32 to extend as shown in FIG. 9, and retract, as shown in FIG. 4, thereby facilitating the compact storage or transport of the mirror assembly 10, in some embodiments. The hinge assembly 35 can include a roll pin to support the hanger bracket 32 when it is used to hang the mirror assembly 10 from a door, ledge, or the like, in some embodiments. In some embodiments, the hinge assembly 35 can use a solid pin or set screws to support the hanger bracket 32 when it is used to hang the mirror assembly 10 from a door, ledge, or the like. A physical stop can be molded into hinge plate 36 to prevent the hanger bracket 32 from rotating further than 90° relative to the suction cup base assembly 30, in some embodiments.

In some embodiments, a telescoping rod 40 extends between the suction cup base assembly 30 and the mirror 20. In some embodiments, the first end 41 of the telescoping rod 40 is secured to the housing 27 of the mirror 20 using a ball joint. The ball joint allows the user of the mirror assembly 10 to pivot and adjust the mirror 20 to obtain the desired position, in some embodiments. In some embodiments, the second end 42 of the telescoping rod 40 is secured to the housing portion 31 of the suction cup base assembly 30, by, for example, a swivel joint such that the suction cup base assembly 30 can be stored against the telescoping rod 40 when the mirror assembly 10 is not in use, thereby facilitating the compact storage or transport of the mirror assembly 10. The telescoping rod 40 can be retracted or extended in order to adjust the height of the mirror 20 or distance from the user or to facilitate the compact storage or transport of the mirror assembly 10, in some embodiments.

In some embodiments, a smooth disc of any suitable size (e.g., 5″ in diameter) can be provided to enhance the stability of the mirror assembly 10 when the telescoping rod 40 is fully extended by removably mounting the suction cup base assembly 30 to the disc using the suction cup 34, thereby providing a larger footprint and increased stability to the mirror assembly 10.

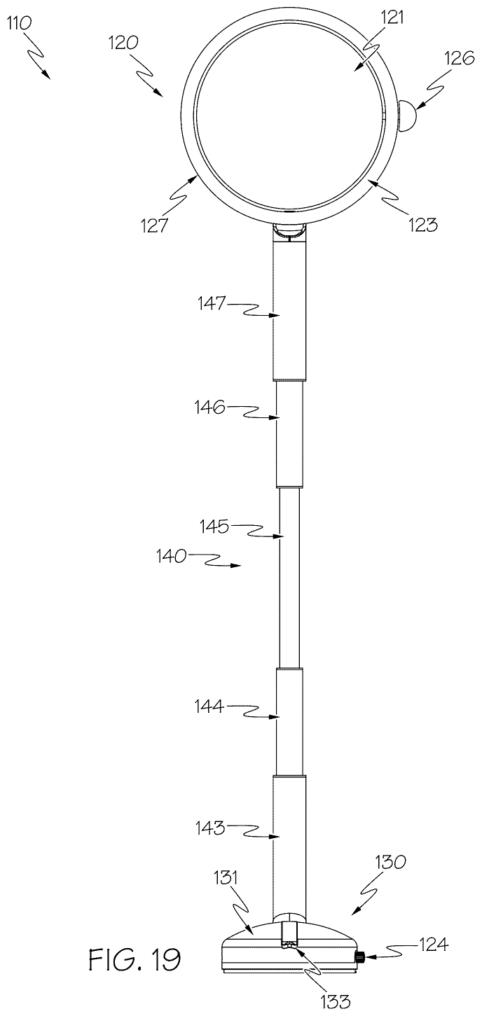

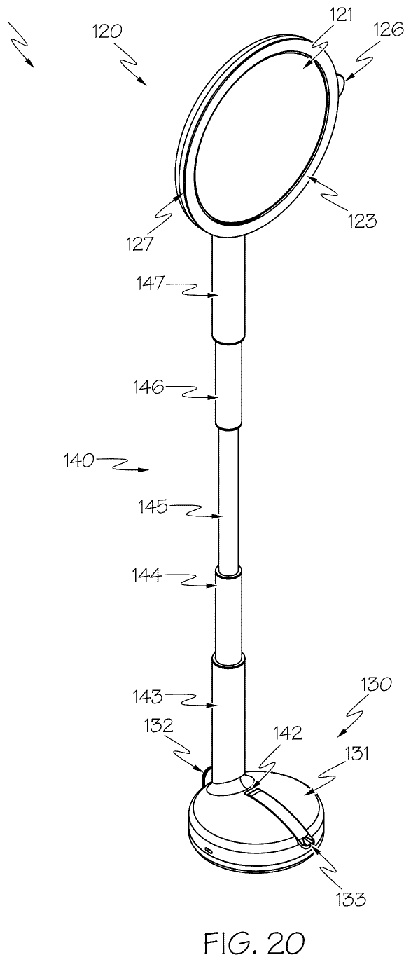

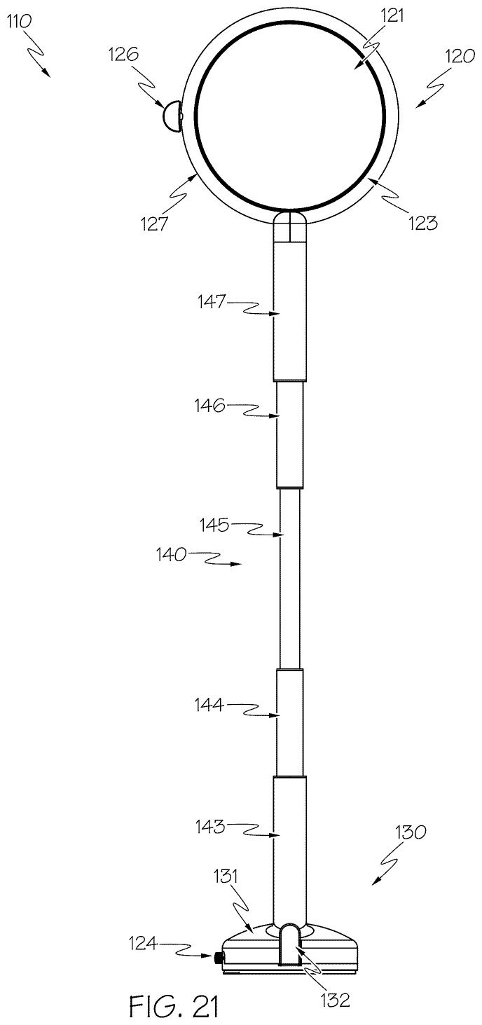

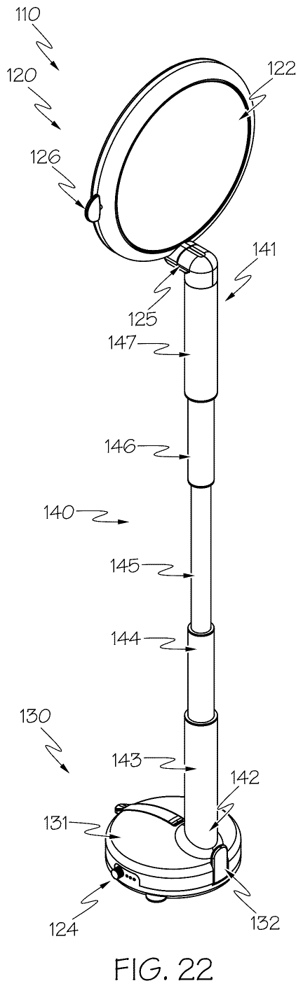

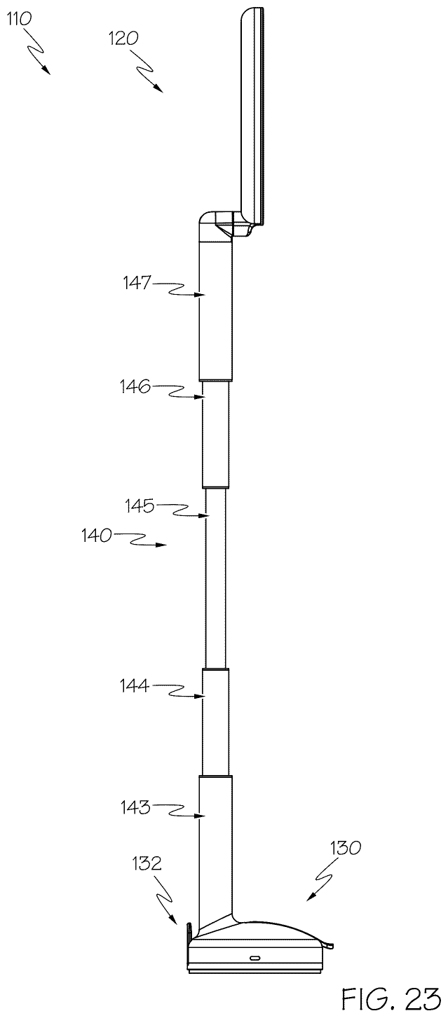

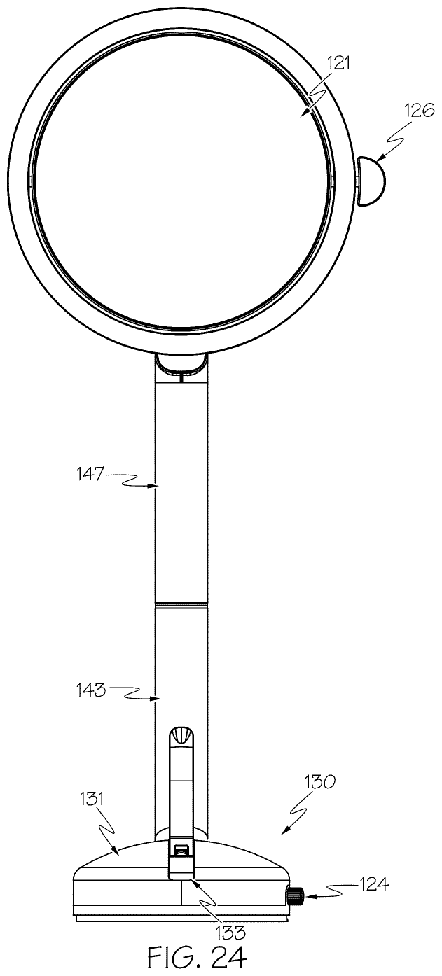

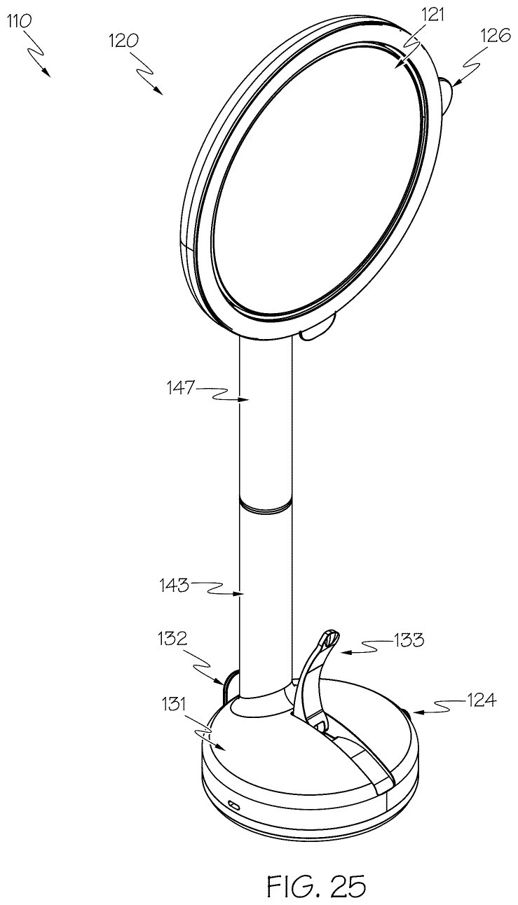

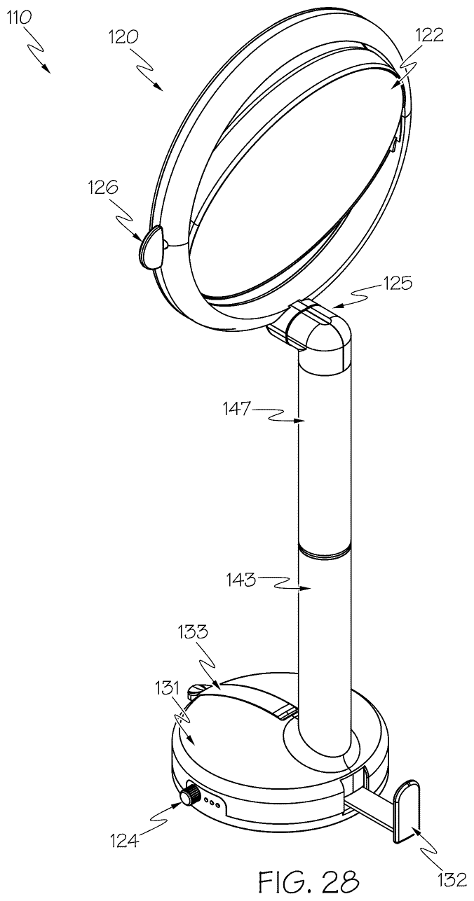

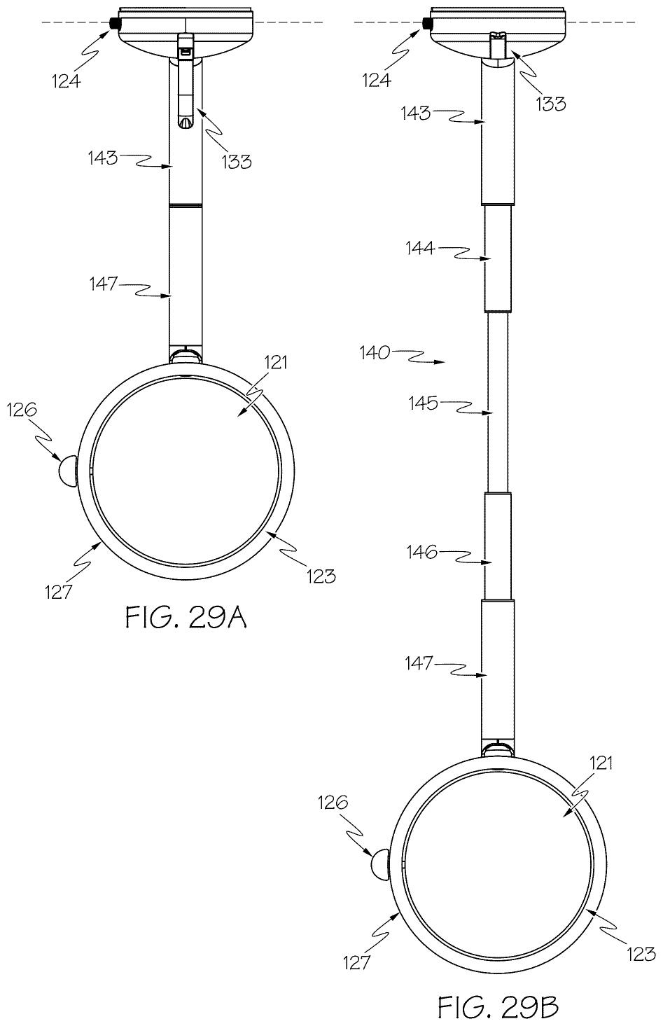

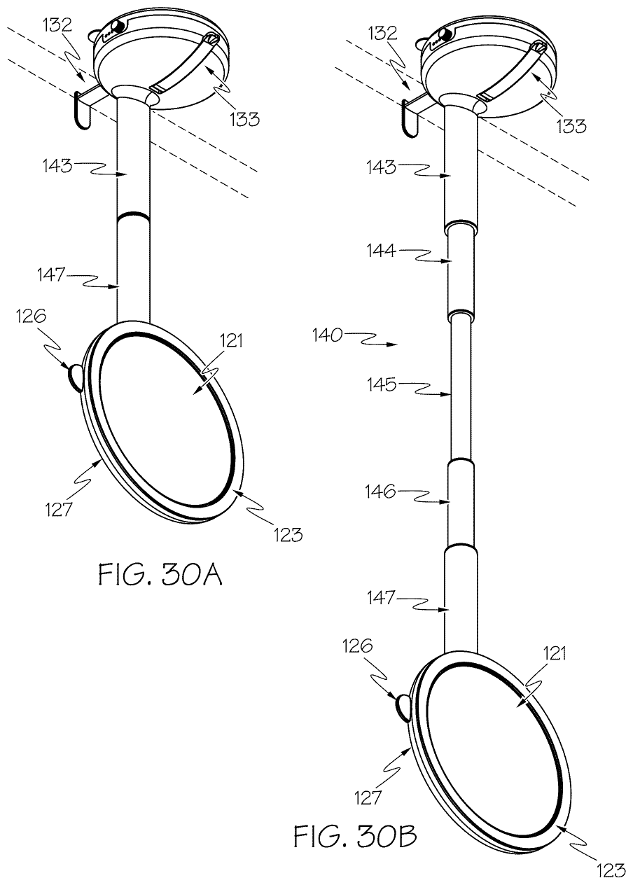

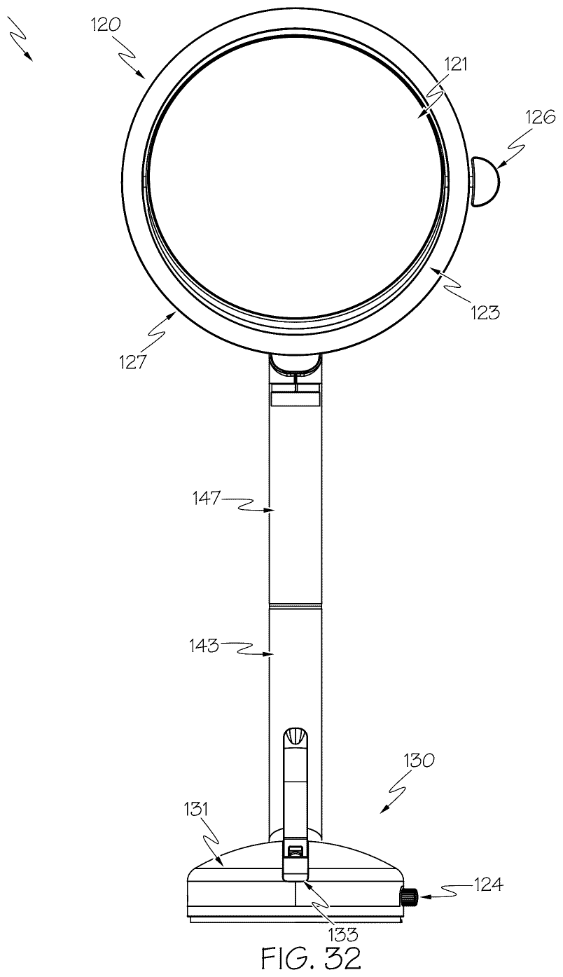

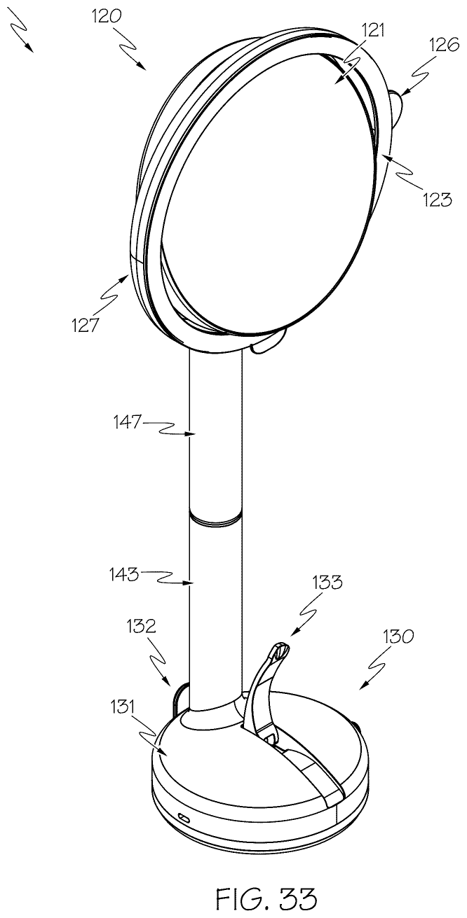

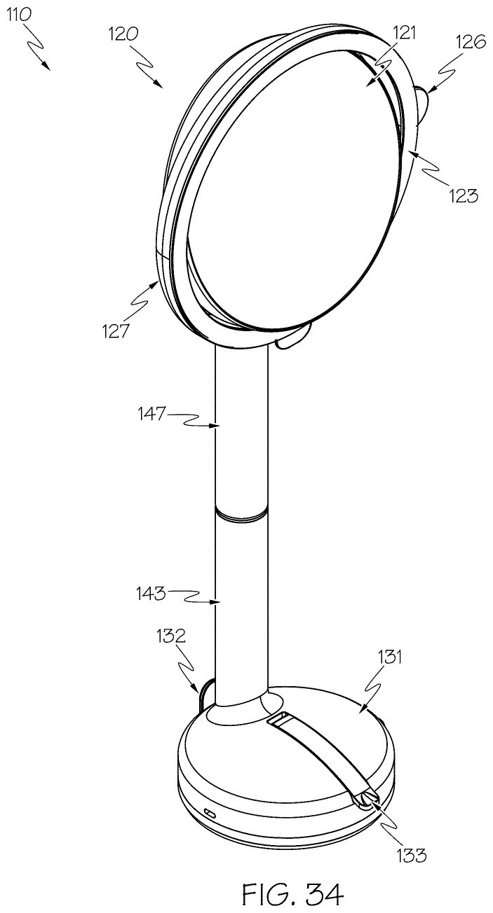

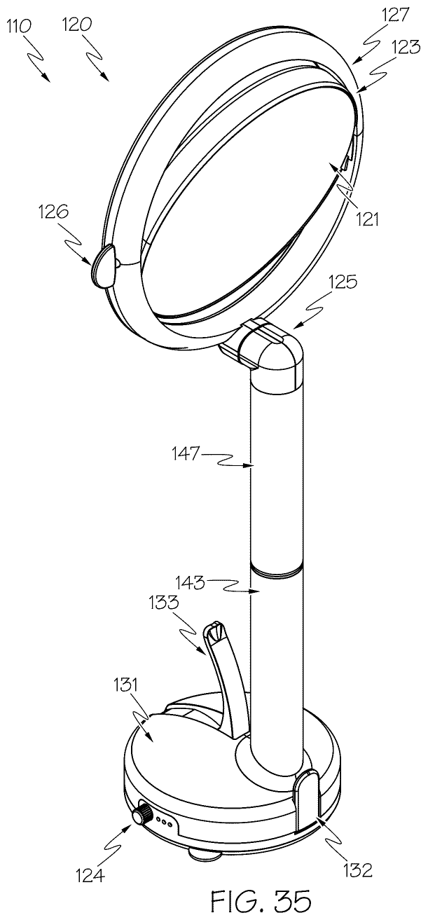

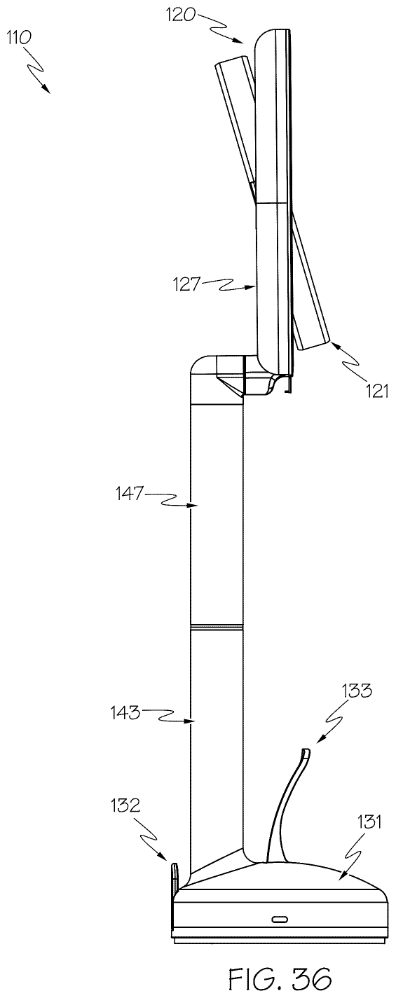

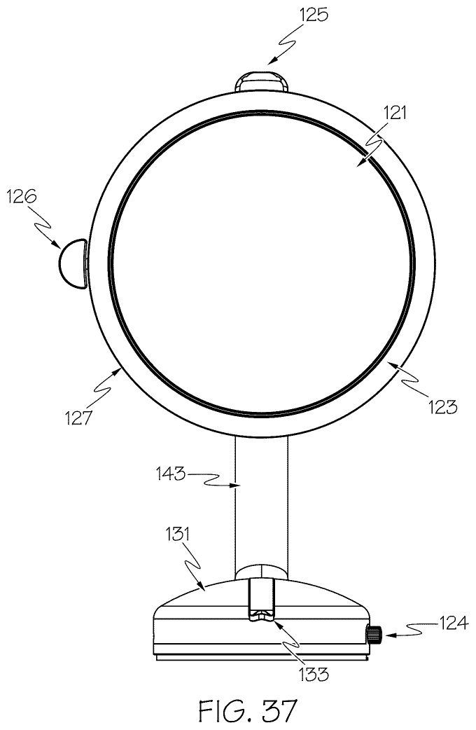

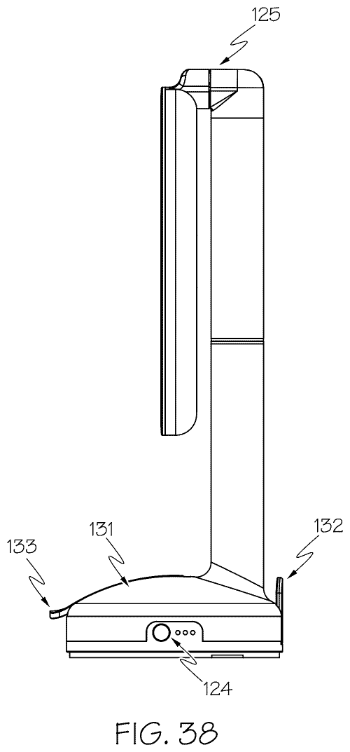

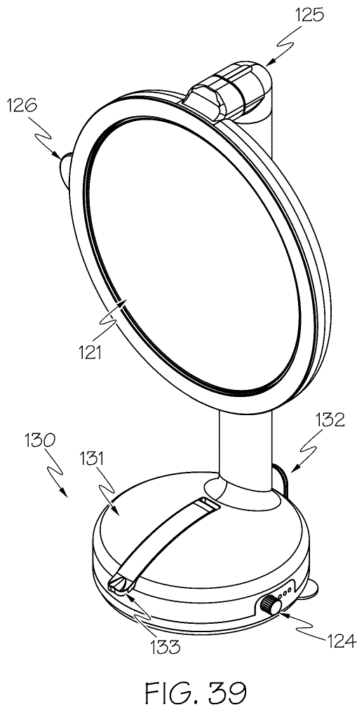

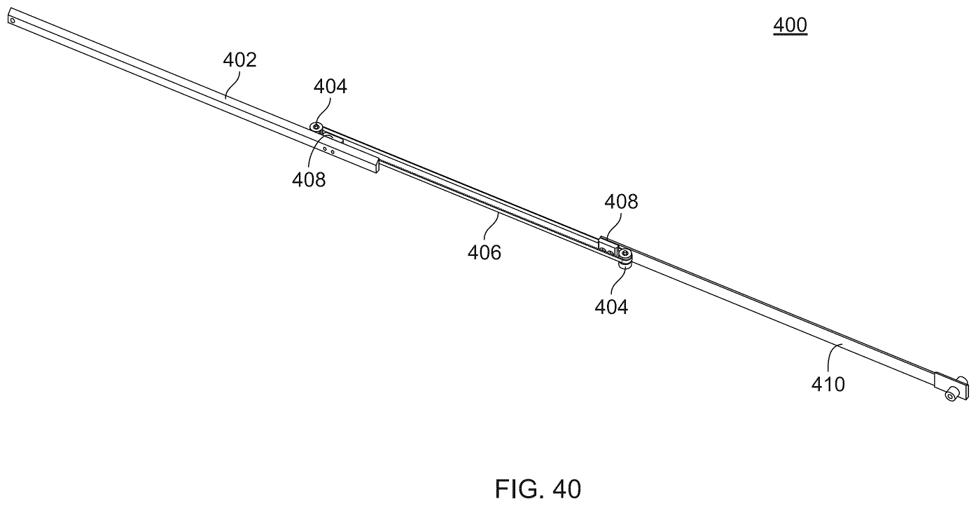

FIGS. 19-39 illustrate an example mirror assembly 110 in accordance with some embodiments. As shown in FIGS. 19 and 22, in some embodiments, mirror assembly 110 comprises a mirror 120, a suction cup base assembly 130, and a multi-stage telescoping rod 140. Mirror 120 can have a first reflective surface 121 on a first side and a second reflective surface 122 on a second side, in some embodiments. In some embodiments, there can be one or more light sources 123 disposed at a periphery of first reflective surface 121 or second reflective surface 122. The light source or sources 123 can be powered by a battery (e.g., a rechargeable battery or batteries) or can be plugged into an electrical outlet, for example, in some embodiments. Rechargeable batteries can be located in suction cup base assembly 130, in some embodiments. A battery retainer plate can hold rechargeable batteries in a pyramid configuration to provide room for a sliding tray that holds hanger bracket 132, in some embodiments.

Mirror assembly 110 can include a switch 124 for activating or deactivating light source or sources 123, for increasing the intensity of the light emitted by the light source, and for decreasing the intensity of the light emitted by light source 123, in some embodiments. As shown in FIG. 19, in some embodiments, switch 124 can be located in suction cup base assembly 130. Light source or sources 123 can include a diffuser screen, in some embodiments. Housing 127 can be secured to a fourth stage 147 of multi-stage telescoping rod 140 using swivel joint 125, in some embodiments. In some embodiments, mirror 120 can also have a lever 126 that when triggered rotates reflective surfaces 121 and 122 relative to light source or sources 123 about an axis normal to the vertical axis of multi-stage telescoping rod 140, for example, thereby allowing a user to view the reflective surface that provides the desired magnification level. Mirror 120 can include a clamp brake that adds friction to the rotation of the first and second reflective surfaces, in some embodiments. In some embodiments, any other suitable one or more methods and axes of rotation can be used to rotate reflective surfaces 121 and 122. In some embodiments, each reflective surface 121 and 122 can be non-magnifying or can be magnifying, and each can provide level a of magnification of, for example, 1×, 3×, 5×, 7×, 10×, 15×, or 20×.

Suction cup base assembly 130 can be substantially hemispherical in shape, comprising a round, flexible, concave diaphragm 134 (i.e., a suction cup) on the front side of the planar surface of the hemisphere, in some embodiments. In some embodiments, the suction cup base assembly 130 can comprise any suitable number of suction cups. In some embodiments, the suction cup base assembly 130 can comprise only one suction cup 134 in order to reduce the size and weight of the mirror assembly 110, thereby increasing portability. The suction cup 134 can be used to removably mount the mirror assembly 110 to a horizontal or vertical surface, in some embodiments. The suction cup 134 can be a locking suction cup or a non-locking suction cup, in some embodiments. In some embodiments, a housing portion 131 is disposed on the reverse side of the planar surface of the hemisphere. The housing portion 131 can be made of any suitable material(s), such as a water-, abrasion-, and stain-resistant material, such as plastic, in some embodiments. In some embodiments, it may be desirable to use a material such as plastic for housing portion 131 since it will resist discoloration and rust that can occur due to conditions in which the mirror assembly can be utilized, e.g., in a damp environment such as a bathroom, adjacent to a water source such as a sink, or near substances that can stain or discolor such as makeup or other grooming products. In some embodiments, the plastic material from which the housing portion 131 of the suction cup base assembly 130 can be comprised can also be flexible such that it will not crack or break if the mirror assembly 110 is dropped. If the suction cup 134 is a locking suction cup, the housing portion 131 of the suction cup base assembly 130 can also include a trigger arm 133 for engaging the suction cup 134 such that it becomes removably mounted to a horizontal or vertical surface, in some embodiments. In some embodiments, trigger arm 133 can be comprised of any suitable material. In some embodiments, due to the conditions in which the mirror assembly 110 can be utilized, e.g., in a damp environment such as a bathroom, or adjacent to a water source such as a sink, the trigger arm 133 can be chosen to be comprised of a water- and rust-resistant material such as stainless steel or aluminum.

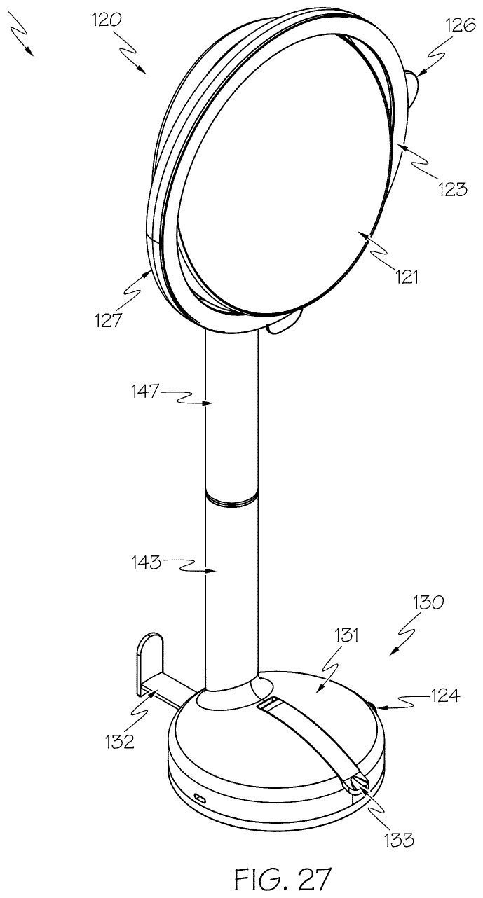

The suction cup base assembly 130 can also include a hanger bracket 132, in some embodiments. The hanger bracket 132 provides support for the mirror assembly 110 to be hung in an inverted manner on a door, a ledge, or the like, in some embodiments. To permit the mirror assembly 110 to be hung in an inverted manner from a door, ledge, or the like, the hanger bracket 132 can have an internal dimension sufficient to accommodate the minimum and maximum standard thickness of an interior door, in some embodiments. In some embodiments, hanger bracket 132 can be shaped as shown, for example, in FIGS. 27, 28, and 30A, or can be shaped in any manner suitable to allow it to support the mirror assembly 110 over a door, ledge, or the like. Hanger bracket 132 can be made of any suitable material, in some embodiments. For example, in some embodiments, the hanger bracket can be made of metal, such as stainless steel, so that it can adequately support the mirror assembly 110 and is preferably thin enough to permit the door on which the mirror assembly 110 can be hung to be closed. In some embodiments due to the conditions in which the mirror assembly 110 can be utilized, e.g., in a damp environment such as a bathroom, or adjacent to a water source such as a sink, hanger bracket 132 can be comprised of a water- and rust-resistant material such as stainless steel.

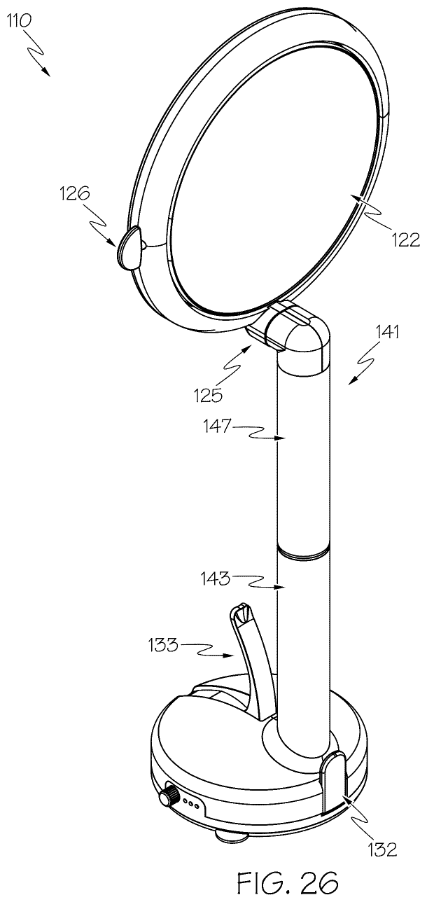

In some embodiments, hanger bracket 132 can be held in place by a sliding tray, thereby allowing hanger bracket 132 to slide in and out of suction cup base assembly 130. In some embodiments, the sliding tray permits hanger bracket 132 to extend, as show in FIG. 27, and retract, as shown in FIG. 26, thereby facilitating the compact storage or transport of mirror assembly 110.

In some embodiments, a multi-stage telescoping rod 140 can extend between suction cup base assembly 130 and mirror 120. In some embodiments, a first end 141 of multi-stage telescoping rod 140 can be secured to housing 127 of mirror 120 using swivel joint 125. Swivel joint 125 can allow the user of mirror assembly 110 to adjust mirror 120 to obtain the desired position, in some embodiments. A second end 142 of multi-stage telescoping rod 140 can be attached to housing portion 131 of suction cup base assembly 130, in some embodiments. In some embodiments, telescoping rod 140 can be retracted or extended in order to adjust the height of mirror 120 or distance from the user or to facilitate the compact storage or transport of mirror assembly 110. Multi-stage telescoping rod 140 can have a base stage 143 and four additional stages, wherein base stage 143 has a certain diameter, stage one 144 and stage two 145 have progressively decreasing diameters, and stage three 146 and stage four 147 have progressively increasing diameters such that the diameter of stage four 147 can be equal to the diameter of base stage 143, in some embodiments.

In some embodiments, a smooth disc of any suitable size (e.g., 5″ in diameter) can be provided to enhance the stability of the mirror assembly 110 when the telescoping rod 140 is fully extended by removably mounting the suction cup base assembly 130 to the disc using the suction cup 134, thereby providing a larger footprint and increased stability to the mirror assembly 110.

In some embodiments, a mirror assembly comprises a mirror, a suction cup base assembly, and a telescoping rod. The mirror can be substantially hemispherical in shape, comprising a flat, circular reflective surface disposed on the front side of the planar surface of the hemisphere, and a housing disposed on the reverse side of the planar surface of the hemisphere, in some embodiments. The housing can have a socket for use in a ball joint by which a first end of a telescoping rod can be secured to the housing or the housing can be secured to the first end of a telescoping rod using a swivel joint, in some embodiments. In some embodiments, there can be one or more light sources disposed at the periphery of the reflective surface. The light source or sources can be powered by a battery (e.g., a rechargeable battery) or can be plugged into an electrical outlet, for example, in some embodiments. The light source or sources can be activated and deactivated by a switch, or the like, which can be located adjacent the light source on the front side of the planar surface of the hemisphere or on the reverse side, or can be located in the suction cup base, for example, in some embodiments. In some embodiments, the reflective surface can be non-magnifying or can be magnifying, providing magnification at a level of, for example, 1×, 3×, 5×, 7×, 10×, 15×, or 20×.

FIGS. 40-68 illustrate further details of a telescoping rod that can be used in place of the telescoping rods described above in accordance with some embodiments.

Turning to FIG. 40, a core telescope assembly 400 of the telescoping rod is shown in accordance with some embodiments. As illustrated, assembly 400 can include an upper arm 402, two pulleys 404, a belt 406, two clamps 408, and a lower arm 410, in some embodiments. As shown, belt 406 wraps around the two pulleys and is clamped to each of arms 402 and 410 by a respective clamp 408, in some embodiments.

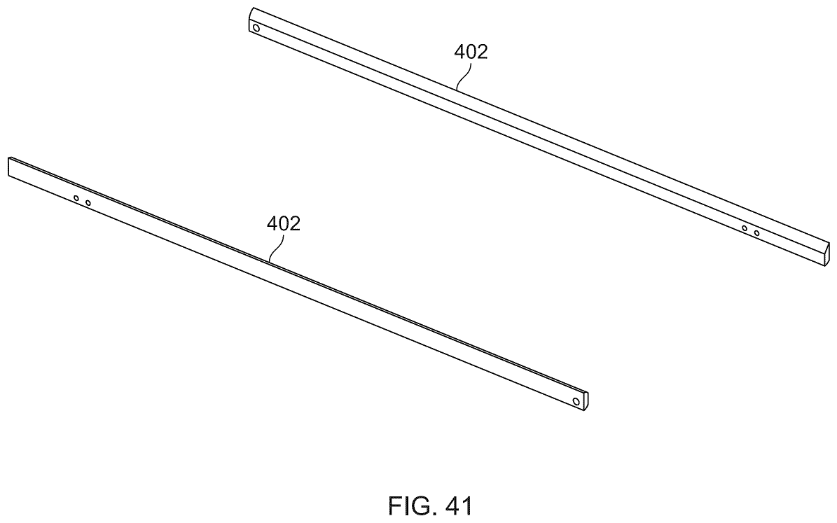

Arms 402 is further illustrated in FIG. 41, in accordance with some embodiments. The arm can have any suitable dimensions (e.g., such as a length of 10 9/16″, a height of 0.425″, and a thickness of 0.145″) and can have any suitable cross-section, such as the cross-section shown in the figure, and other features, in some embodiments. The arm can be made of any suitable material, such as injection-molded plastic, in some embodiments. In some embodiments, the arm can be made of glass-filled, injection-molded plastic.

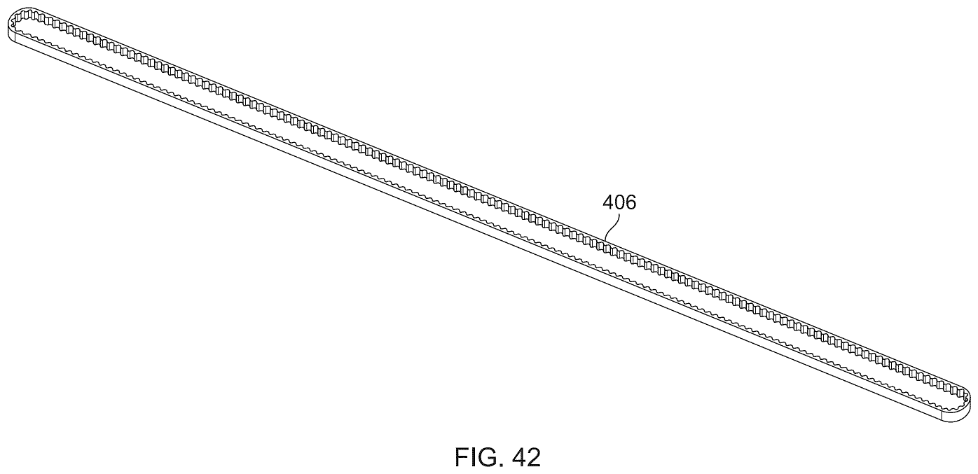

FIG. 42 illustrates an example of belt 406, in accordance with some embodiments. As shown, belt 406 can be a toothed belt, in some embodiments. In some embodiments, belt 406 can be toothless (smooth) and have any suitable cross-section. In some embodiments, belt 406 can have any suitable dimensions, such as: a width of ⅛″, 4 mm, or any other suitable value; a pitch is 0.080″ (approx. 2 mm) or any other suitable value; and a length suitable to wrap around the two pulleys. In some embodiments, when implemented with teeth, belt 406 can have any suitable number of teeth, such as 235 teeth or any other suitable number. In some embodiments, belt 406 can be made of any suitable materials, such as urethane. In some embodiments, belt 406 can be replaced with another object that performs a similar function, such as a chain (e.g., similar in structure to a bicycle chain), a cable, a wire, a rope, etc.

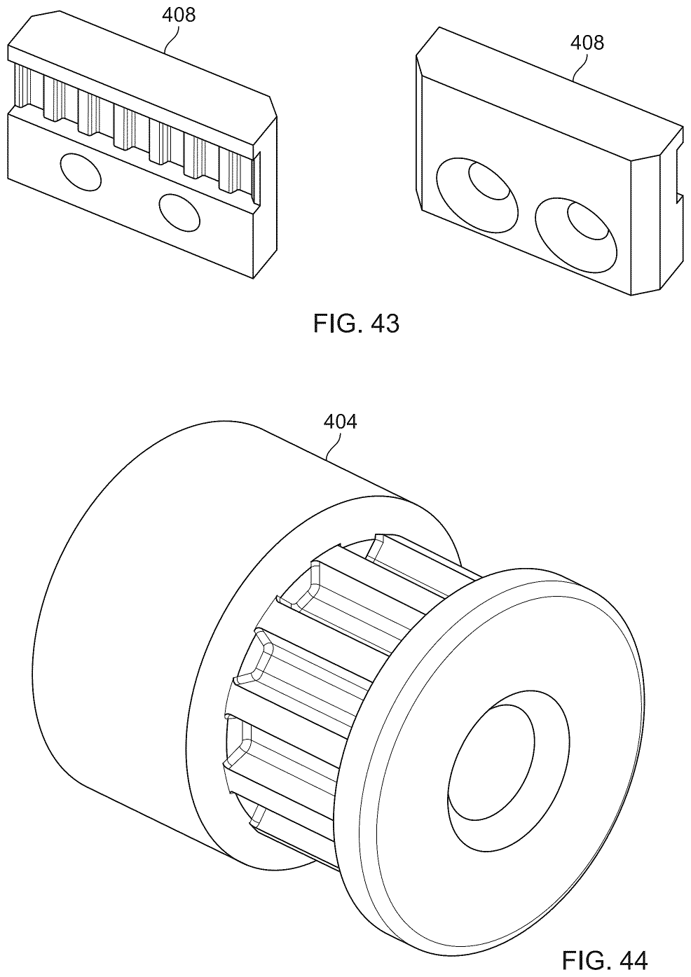

FIG. 43 illustrates an example of clamp 408 in accordance with some embodiments. As shown, clamp 408 can include a suitable carved-out section to receive a portion of belt 406, in some embodiments. When belt 406 is implemented with teeth, clamp 408 can include suitable complementary teeth to engage the teeth on the belt, in some embodiments. When implemented with a toothless belt or the belt is replaced with a cable, wire, or rope, clamp 408 can include any suitable surface texture (such as a ridged or jagged texture) to cause the belt, cable, wire, or rope not to slip with respect to the clamp, in some embodiments. As also shown, in some embodiments, the clamp can include holes so that the clamp can be attached to an arm via any suitable fastener, such as a screw, rivet, or other fastener. In some embodiments, the clamp can be glued or welded to the arm. In some embodiments, the clamp can have any suitable dimensions. The clamp can be made of any suitable material, such as injection-molded plastic, in some embodiments. In some embodiments, the clamp can be made of glass-filled, injection-molded plastic.

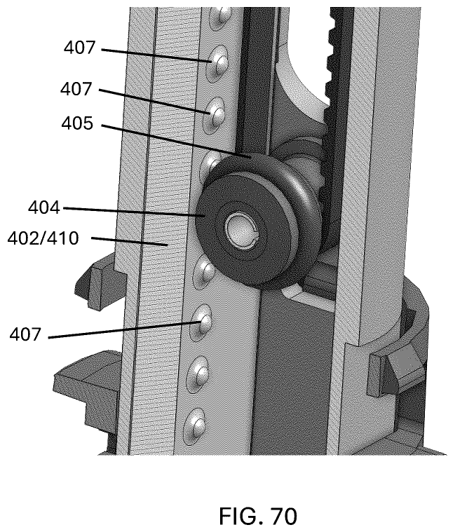

FIG. 44 illustrates an example of pulley 404 in accordance with some embodiments. As shown, pulley 404 can include a suitable carved-out section to receive a portion of belt 406, in some embodiments. When belt 406 is implemented with teeth, pulley 404 can include suitable complementary teeth to engage the teeth on the belt, in some embodiments. When implemented with a toothless belt or the belt is replaced with a cable, wire, or rope, pulley 404 can include any suitable surface texture in the portion that engages the belt, cable, wire, or rope, in some embodiments. As also shown, in some embodiments, the pulley can include a hole so that the pulley can be fixed in position in the telescoping rod using any suitable fastener, such as a screw or pin (e.g., spring pin or non-spring pin). In some embodiments, the pulley can have any suitable dimensions. The pulley can be made of any suitable material, such as injection-molded plastic, in some embodiments. In some embodiments, the pulley can be made of glass-filled, injection-molded plastic. In some embodiments, as shown in FIG. 70, pulley 404 can include a groove for an o-ring 405 that can press against a corresponding rod 402/410 to which the pulley is adjacent. This can cause friction between the pulley and the rod and slow the rate at which the pulley rotates, in some embodiments. In some embodiments, to further slow the rate at which the pulley rotates, bumps 407, and/or indentations, can be located on/in rod 402/410 so that the o-ring rolls over the bumps and/or in and out of the indentations. Such bumps and/or indentations can have any suitable size and spacing, in some embodiments.

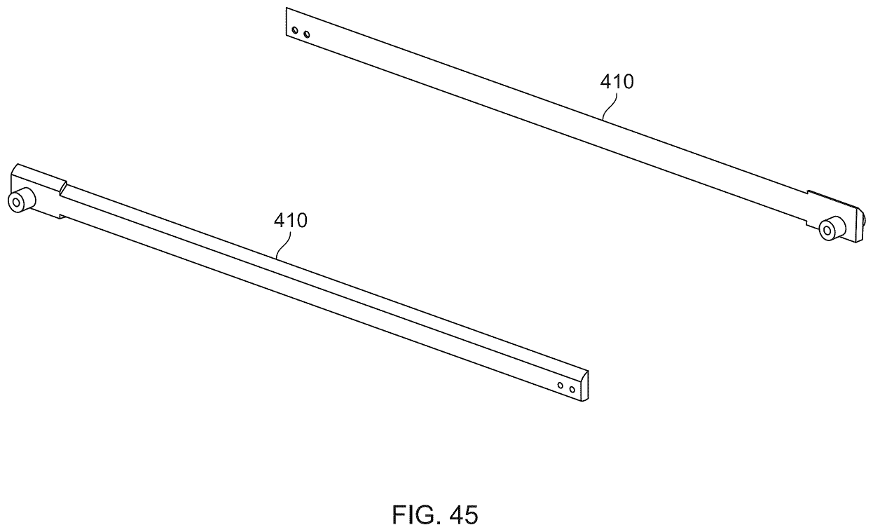

Arms 410 is further illustrated in FIG. 45, in accordance with some embodiments. The arm can have any suitable dimensions (e.g., such as a length of 10 9/16″, a height of 0.425″, and a thickness of 0.145″) and can have any suitable cross-section, such as the cross-section shown in the figure, and any other features, in some embodiments. The arm can be made of any suitable material, such as injection-molded plastic, in some embodiments. In some embodiments, the arm can be made of glass-filled, injection-molded plastic.

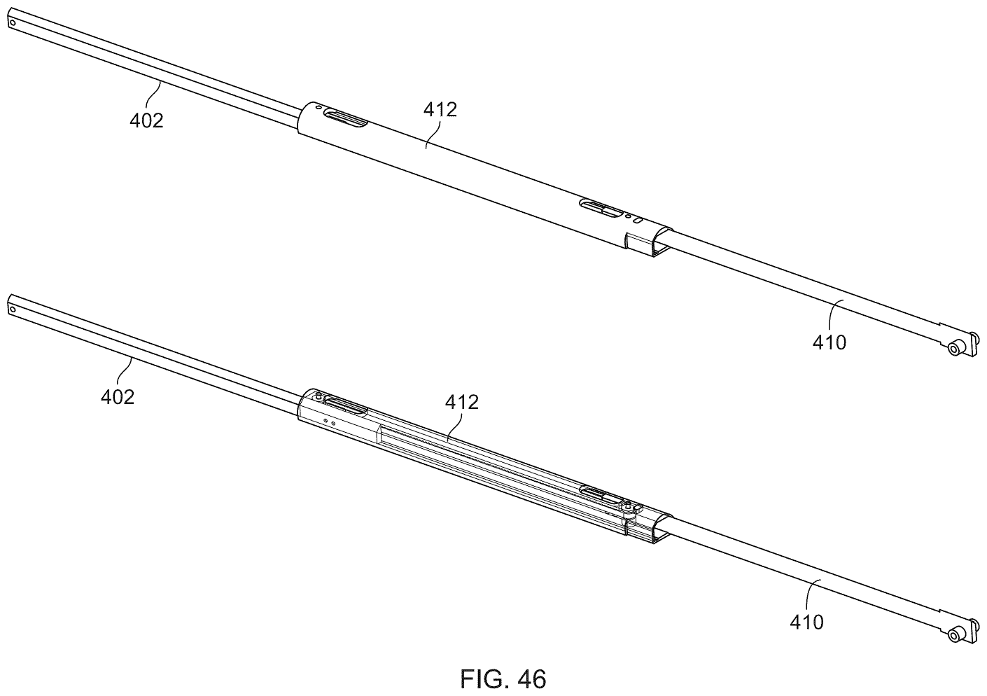

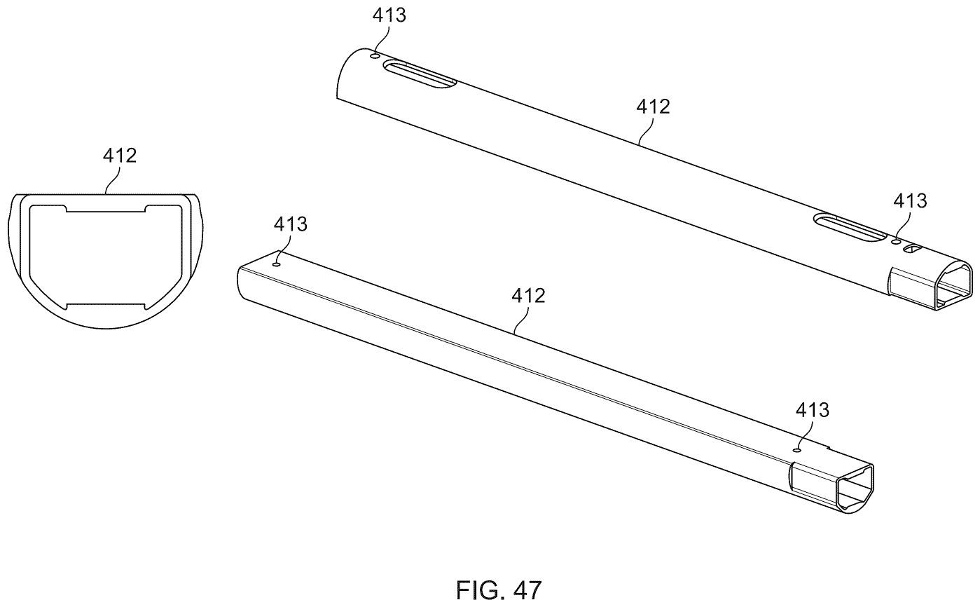

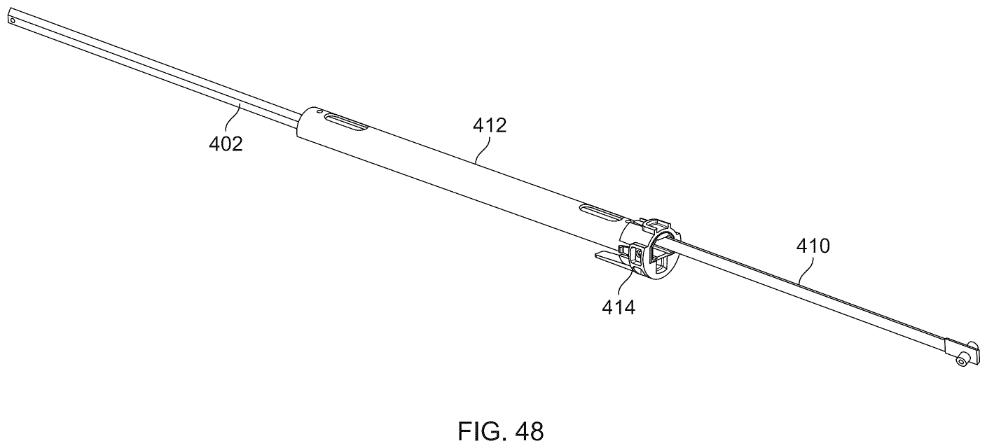

Turning to FIG. 46, an illustration of assembly 400 (including arms 402 and 410) inside a core tube 412 is shown, in accordance with some embodiments. More detailed illustrations of core tube 412 are shown in FIG. 47, in accordance with some embodiments. As illustrated, core tube 412 can include holes 413 through which pins or screws can be placed to secure pulleys with respect to the core tube. The core tube can have any suitable dimensions and can have any suitable cross-section, such as the cross-section shown in the figure, and any other features, in some embodiments. The core tube can be made of any suitable material, such as extruded aluminum with secondary machined features, in some embodiments.

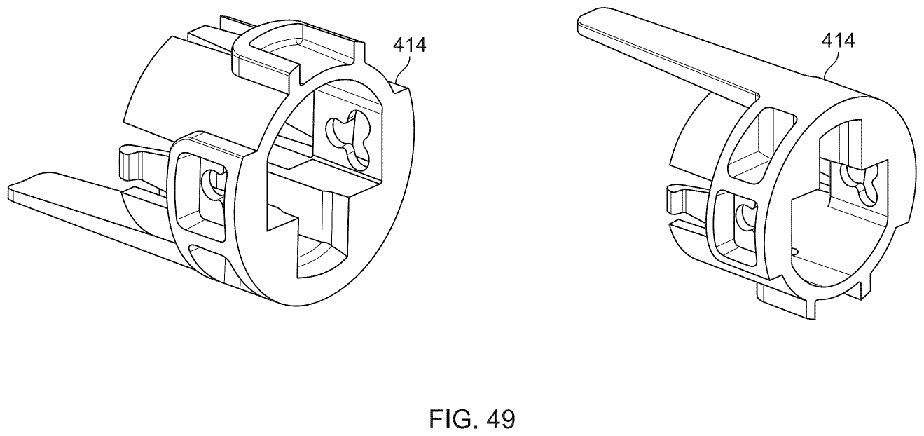

FIG. 48 shows the components of FIG. 46 with the addition of an end cap 414, in accordance with some embodiments. End cap 414 is further illustrated in FIG. 49 in some embodiments. End cap 414 can have any suitable shape and dimensions, such as the shape shown in the figure and can be made of any suitable material, such as injection molded Delrin, in some embodiments. In some embodiments, end cap 414 can be sized to have an outer surface that slides on an inside surface of a bottom tube described below.

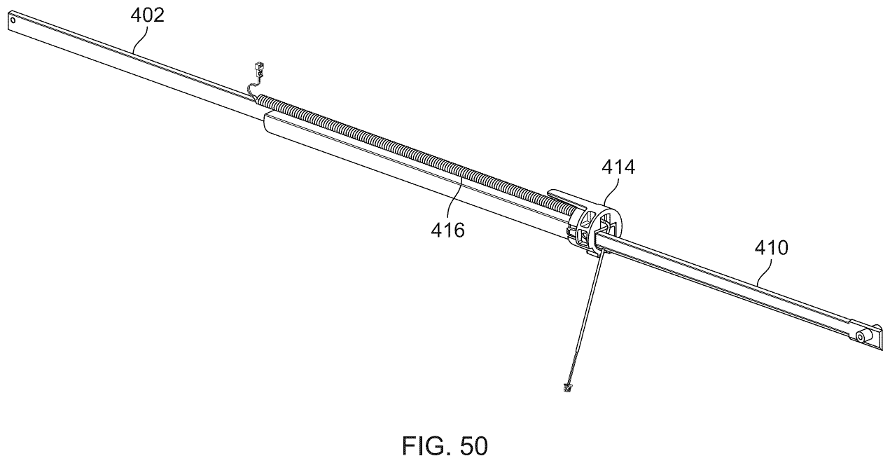

FIG. 50 shows the components of FIG. 48 with the addition of a cable 416, in accordance with some embodiments. As shown cable 416 can sit on top of core tube 412 and pass through a hole in end cap 414. Cable 416 can be formed from any suitable material and have any suitable dimensions, in some embodiments. As shown, cable 416 can be coiled to allow the cable to stretch between the minimum length of the telescoping rod and the maximum length of the telescoping rod. In some embodiments, rather than being coiled, cable 406 can be non-coiled and formed from a material that can be suitably stretched.

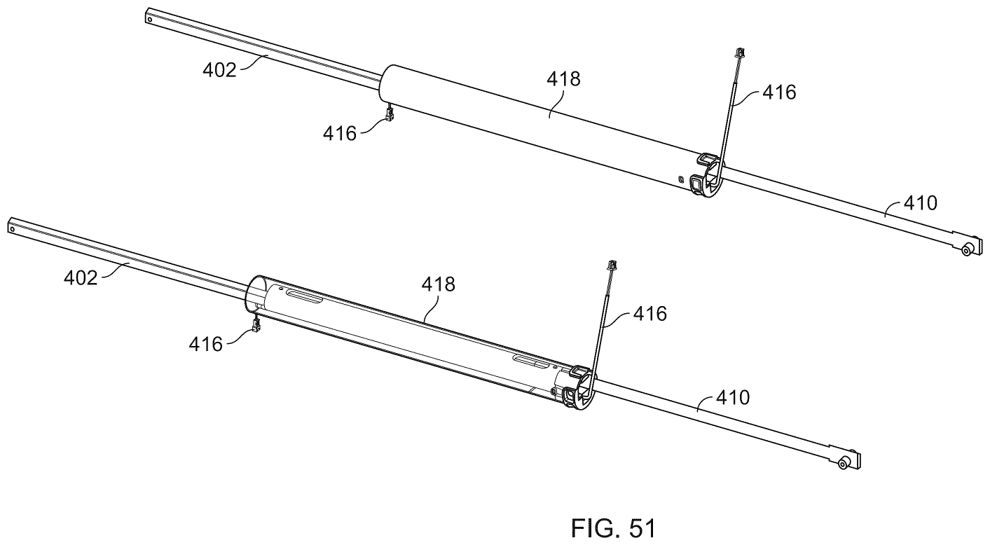

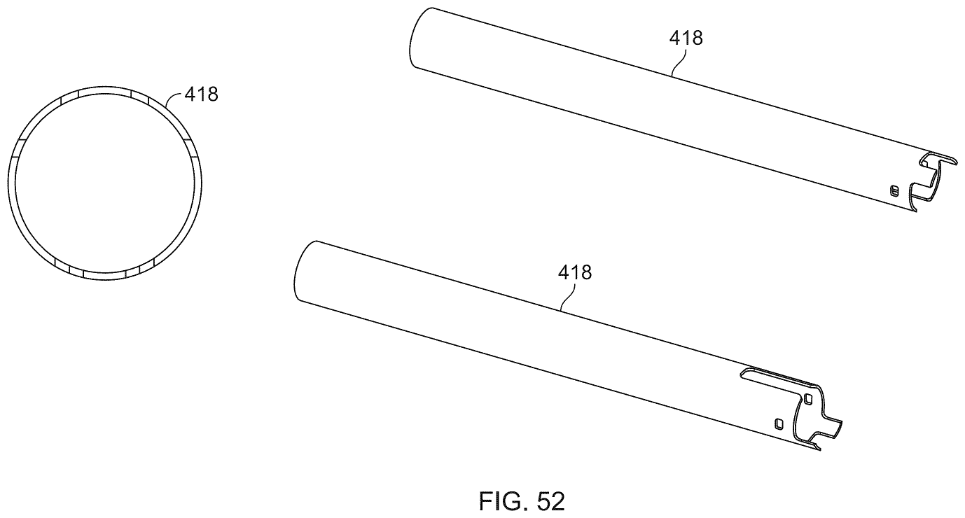

FIG. 51 shows the components of FIG. 50 inside a middle tube 418, in accordance with some embodiments. More detailed illustrations of middle tube 418 are shown in FIG. 52, in accordance with some embodiments. The middle tube can have any suitable dimensions (e.g., a length of 10 13/16″ and an outside diameter of 1.10″) and can have any suitable cross-section, such as the cross-section shown in the figure, and any other features, in some embodiments. The middle tube can be made of any suitable material, such as extruded aluminum with secondary machined features, in some embodiments.

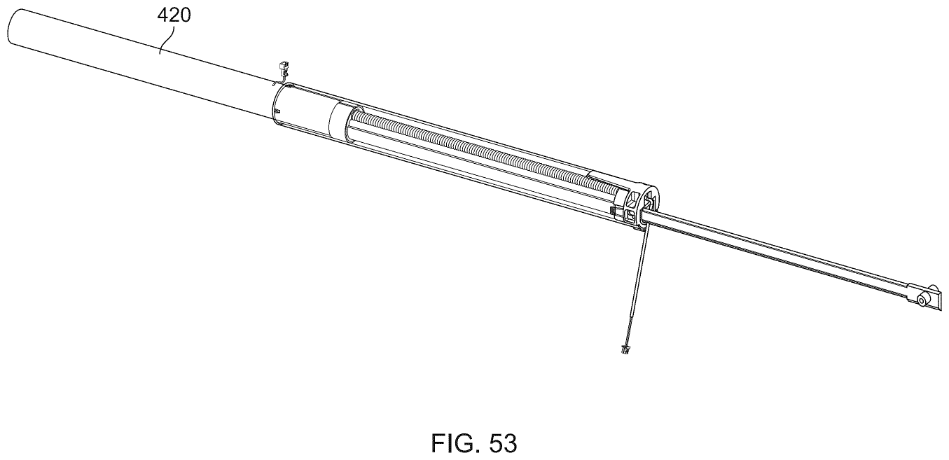

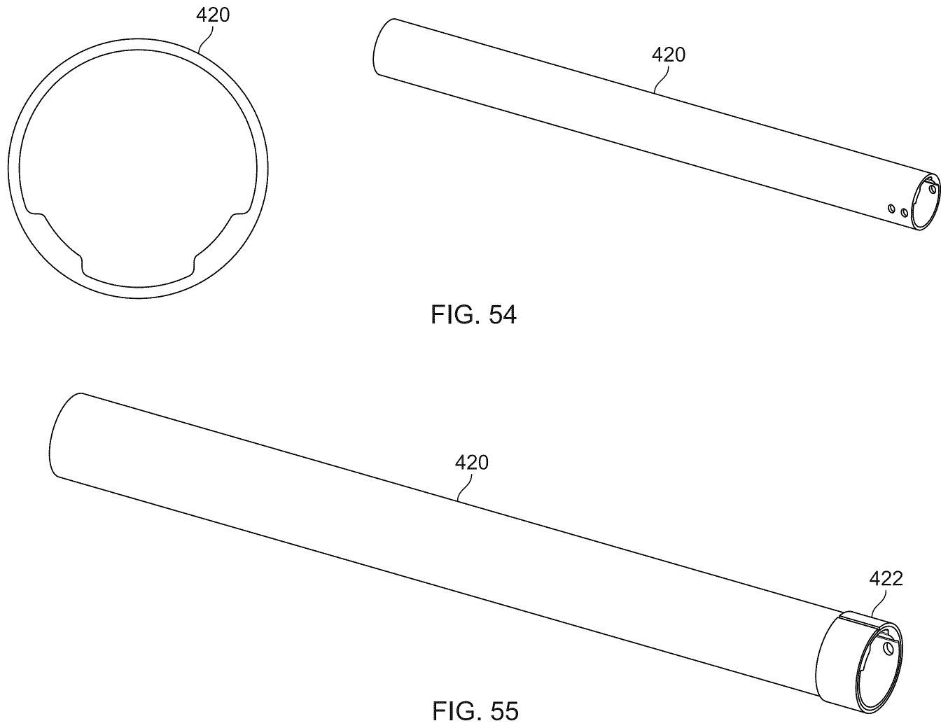

FIG. 53 shows the components of FIG. 51 with a top tube 420. More detailed illustrations of top tube 420 are shown in FIG. 54, in accordance with some embodiments. The top tube can have any suitable dimensions (e.g., a length of 10 1/16″ and an outside diameter of 0.930″) and can have any suitable cross-section, such as the cross-section shown in the figure, and any other features, in some embodiments. The top tube can be made of any suitable material, such as extruded aluminum with secondary machined features, in some embodiments.

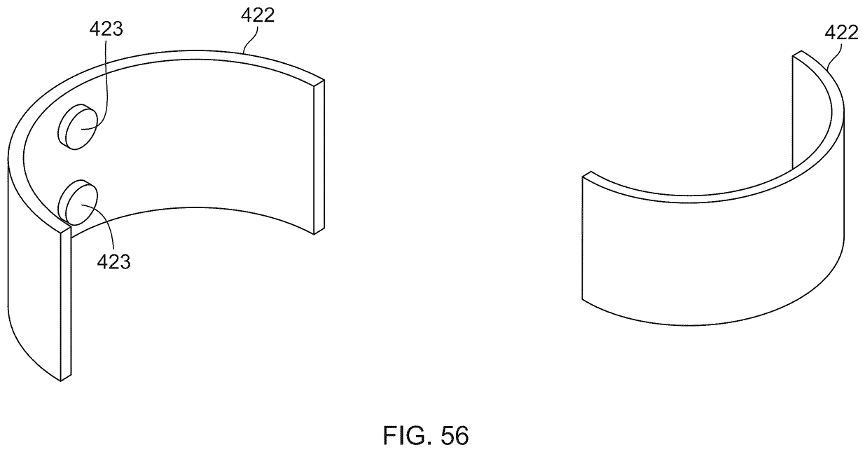

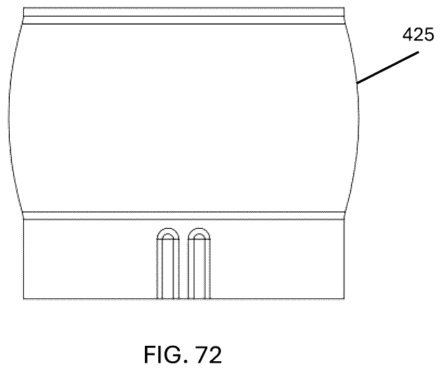

FIG. 55 shows an illustration of top tube 420 of FIG. 54 along with a bushing 422, in accordance with some embodiments. Bushing 422 is further illustrated in FIG. 56 in some embodiments. Bushing 422 can have any suitable shape and dimensions, such as the shape shown in the figure and can be made of any suitable material, such as injection molded Delrin, in some embodiments. In some embodiments, as shown, bushing 422 can be formed from two half rings, and each half ring can include rivets 423 that can be flattened when end cap half rings are placed on top tube 420 so that the half rings are secure to the top tube. In some embodiments, as shown in FIG. 72, a bushing 425 can be used in place of bushing 422. As shown, bushing 425 has a diameter in a middle portion that is wider than other portions of the bushing. This can cause the bushing to apply friction to the inner surface of the middle tube and thereby slow movement between the top tube and the middle tube.

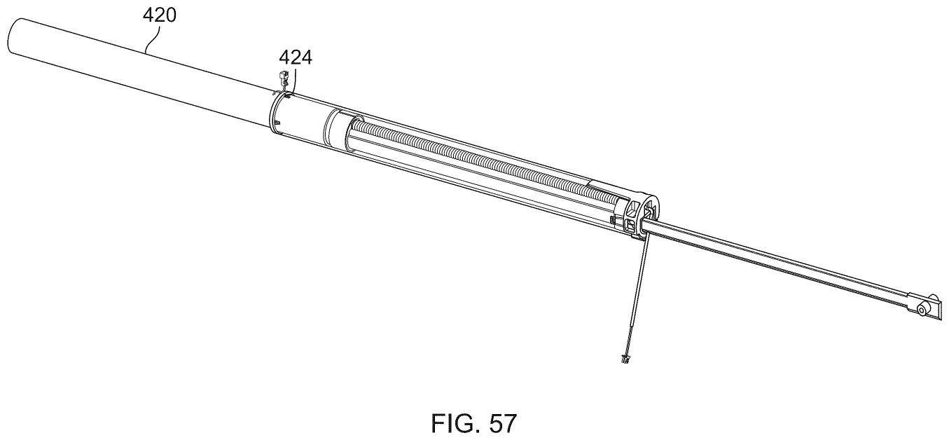

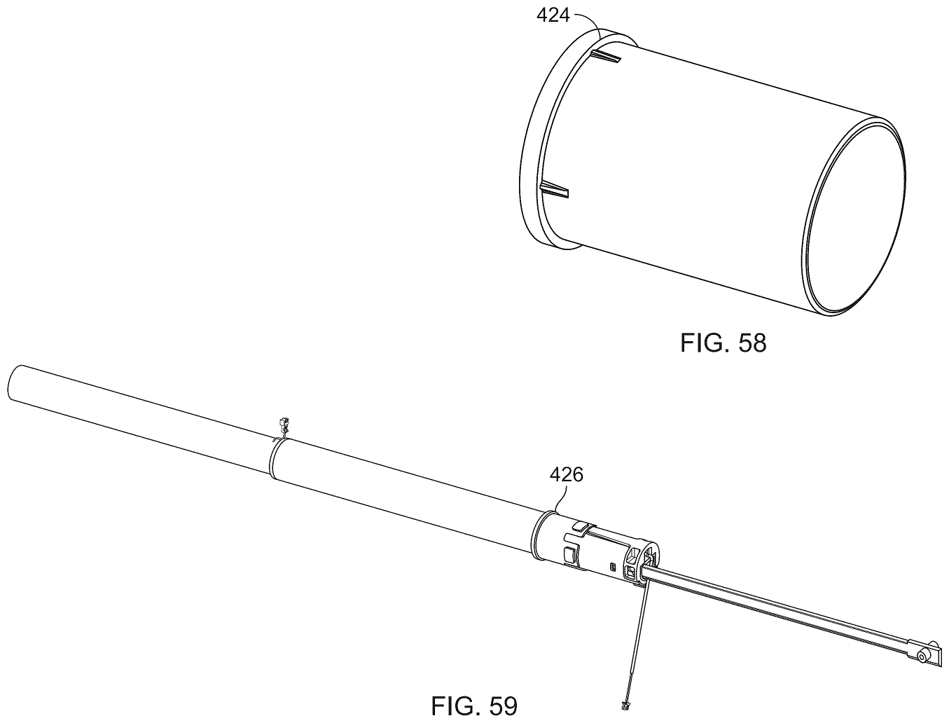

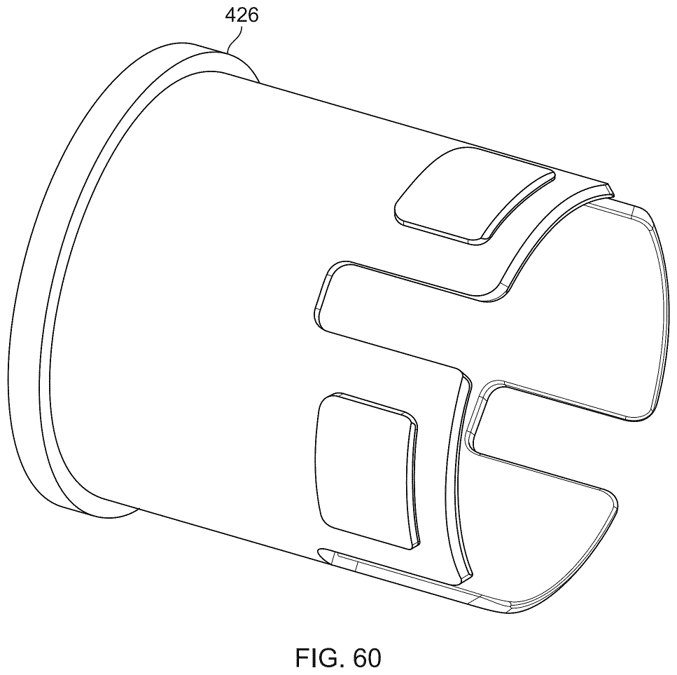

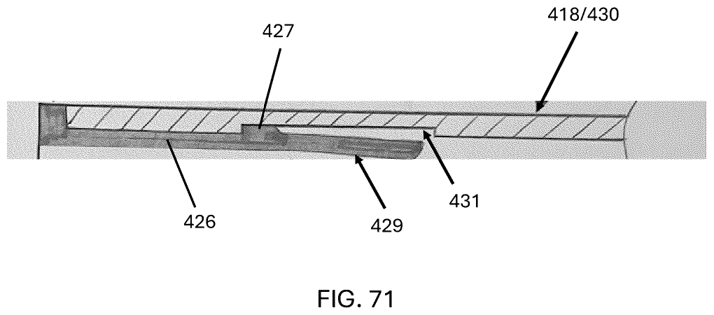

FIG. 57 shows an illustration of the components of FIG. 55 along with a bushing 424, in accordance with some embodiments. Bushing 424 is further illustrated in FIG. 58 in accordance with some embodiments. Bushing 424 can have any suitable shape and dimensions, such as the shape shown in the figure and can be made of any suitable material, such as injection molded Delrin, in some embodiments. In some embodiments, instead of bushing 424, bushing 426 shown in FIG. 60 (and described in connection therewith) can be used in the same location as shown for bushing 424. When bushing 426 is used, as shown in FIG. 71, a raised portion 427 of the bushing can press on an inside surface of middle tube 418. This causes a finger of bushing 426 to press against an outside surface of top tube 420, thereby slowing movement between the middle tube and the top tube.

FIG. 59 shows an illustration of the components of FIG. 57 along with a bushing 426, in accordance with some embodiments. Bushing 426 is further illustrated in FIG. 60 in accordance with some embodiments. Bushing 426 can have any suitable shape and dimensions, such as the shape shown in the figure and can be made of any suitable material, such as injection molded Delrin, in some embodiments. When bushing 426 is used, as shown in FIG. 71, a raised portion 427 of the bushing can press on an inside surface of a bottom tube 430 (described below). This causes a finger of bushing 426 to press against an outside surface of middle tube 418, thereby slowing movement between the middle tube and the bottom tube. In some embodiments, instead of bushing 426, bushing 424 shown in FIG. 58 (and described in connection therewith) can be used in the same location as shown for bushing 426.

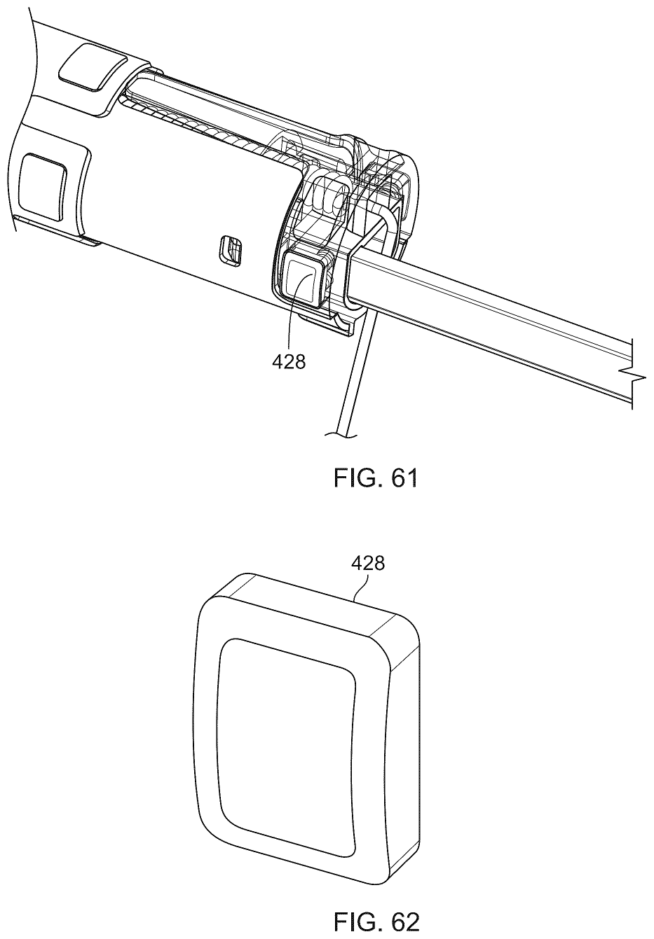

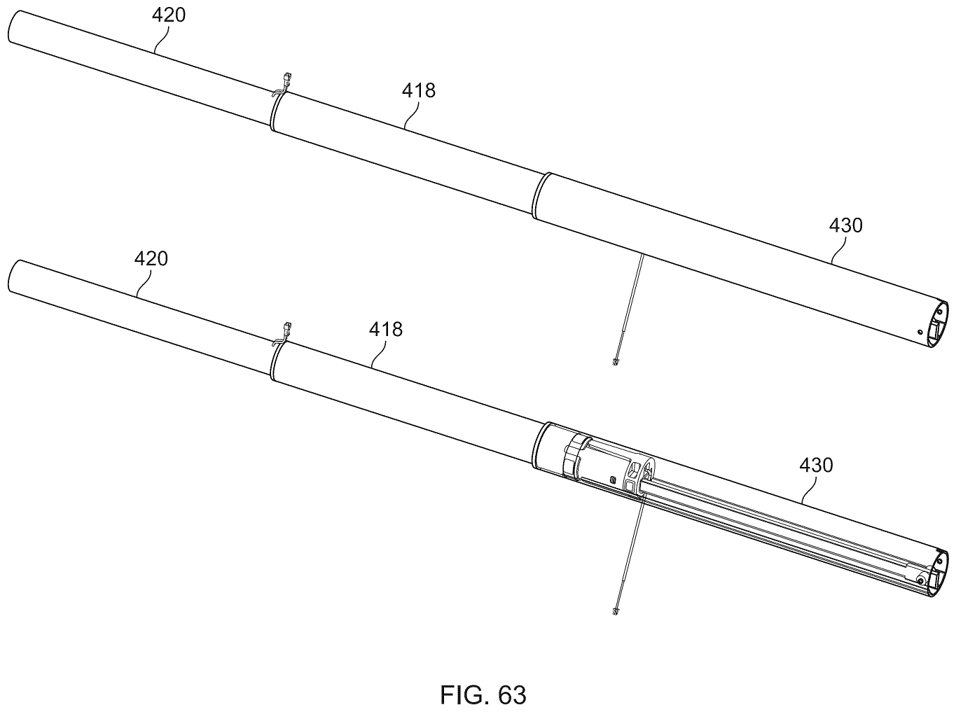

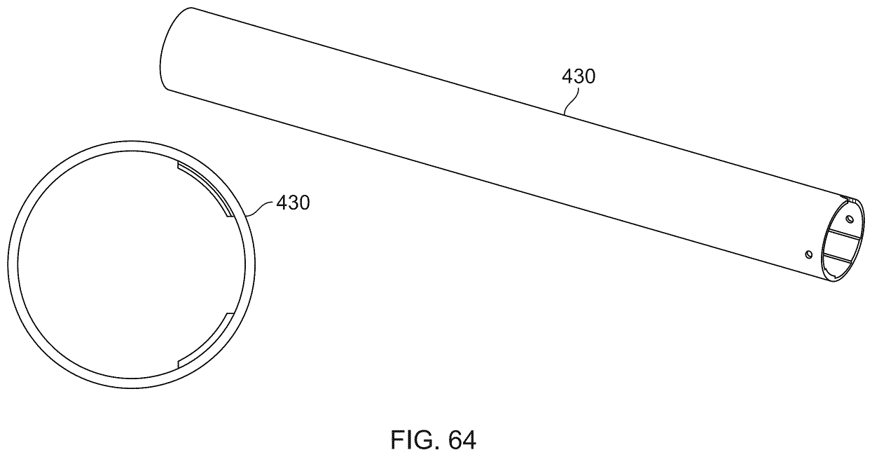

FIG. 61 shows an illustration of a friction pad 428 shown in end cap 414, in accordance with some embodiments. Friction pad 428 is further illustrated in FIG. 62 in accordance with some embodiments. Friction pad 428 can have any suitable shape and dimensions, such as the shape shown in the figure and can be made of any suitable material, such as a polymer (e.g., nylon, aliphatic polyamide, thermoplastic polyurethane, silicone), metal (e.g., brass, copper), a composite (e.g., fiberglass, carbon fiber), a ceramic, and/or any other suitable material that can provide a consistent friction value, in some embodiments. Friction pad 428 can be configured to rub against bottom tube 430 shown in FIGS. 63 and 64 and described below, and slow the rate at which the telescoping rod lengthens and shortens. In some embodiments, the pad is longer in a first dimension along the axis of the middle tube than it is wide in a second dimension that is perpendicular to the first dimension.

FIG. 63 shows an illustration of top tube 420 and middle tube 418 along with bottom tube 430, in accordance with some embodiments. More detailed illustrations of bottom tube 430 are shown in FIG. 64, in accordance with some embodiments. The bottom tube can have any suitable dimensions (e.g., a length of 11 11/16″ and an outside diameter of 1.295″) and can have any suitable cross-section, such as the cross-section shown in the figure, and any other features, in some embodiments. The top tube can be made of any suitable material, such as extruded aluminum with secondary machined features, in some embodiments.

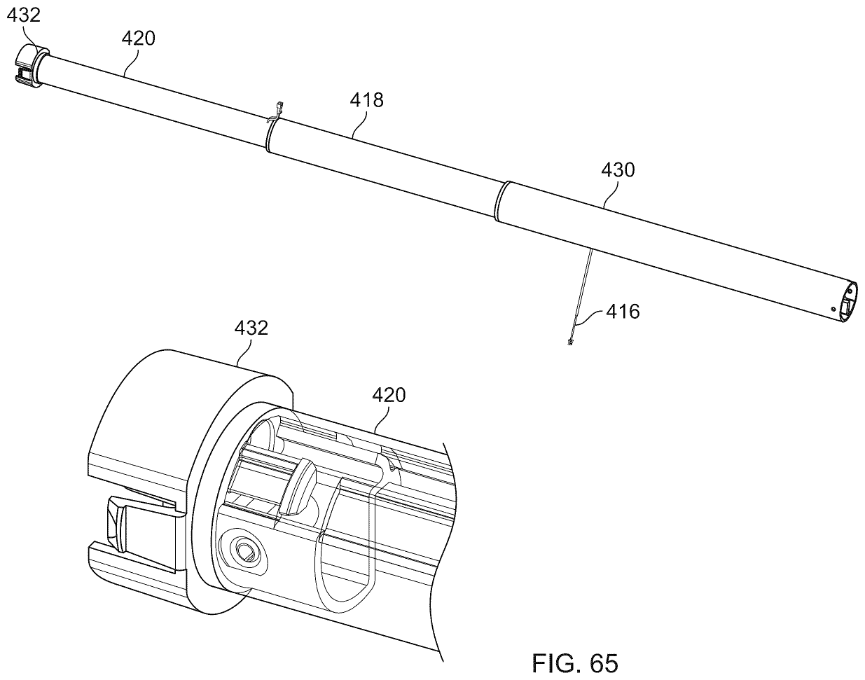

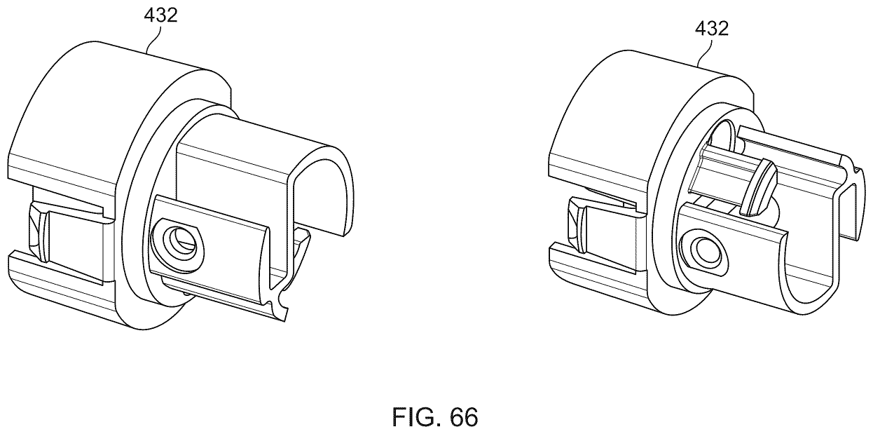

FIG. 65 shows the components of FIG. 63 with the addition of an end cap 432, in accordance with some embodiments. End cap 432 is further illustrated in FIG. 66 in some embodiments. End cap 432 can have any suitable shape, such as the shape shown in the figure, dimensions, and can be made of any suitable material, such as injection molded Delrin, in some embodiments. Clips on the sides of end cap 432 can attach the telescoping rod to a ball joint or swivel joint at the back of mirror 20 or 120 described above.

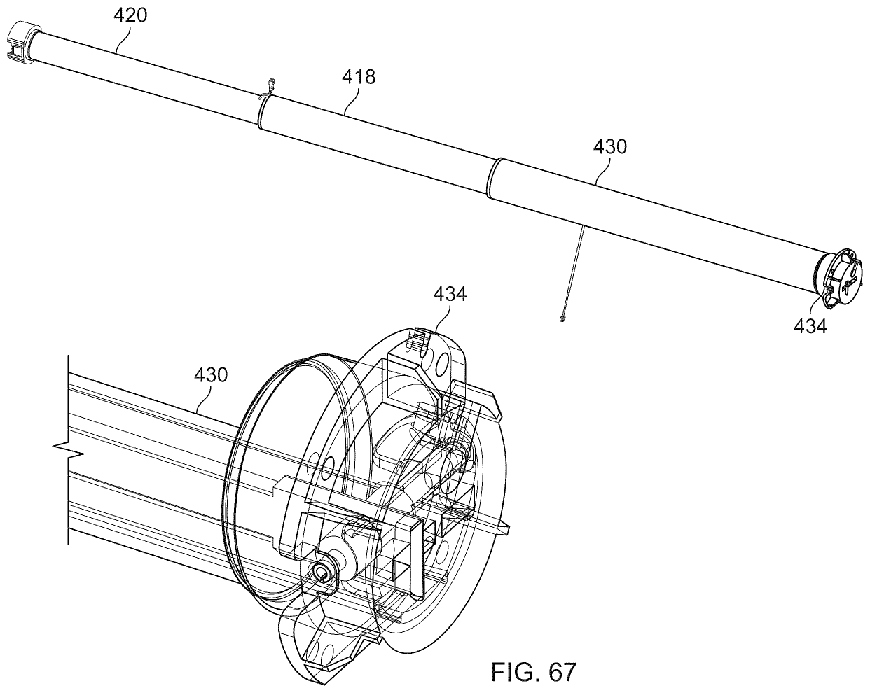

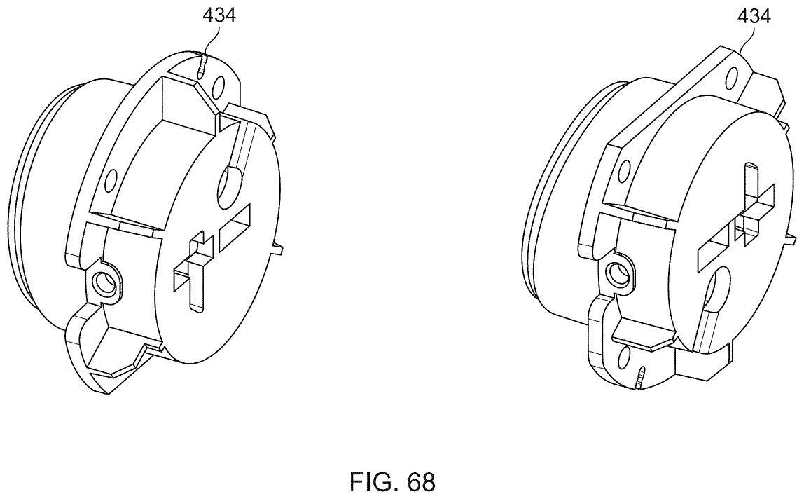

FIG. 67 shows the components of FIG. 65 with the addition of an end cap 434, in accordance with some embodiments. End cap 434 is further illustrated in FIG. 68 in some embodiments. End cap 434 can have any suitable shape, such as the shape shown in the figure, dimensions, and can be made of any suitable material, such as injection molded Delrin, in some embodiments. Holes in end cap 434 can connect the telescoping rod to the base assembly 30 or 130, described above.

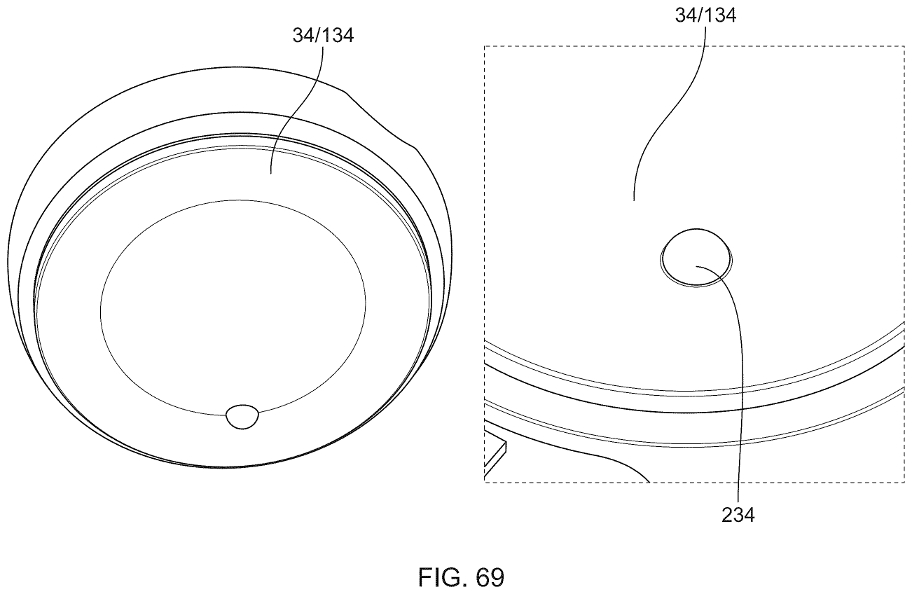

FIG. 69 shows an example of a suction cup 34/134 that can be used as suction cup 34 or 134 described above. As shown, suction cup 34/134 can include a bump 234. When the center of the suction cup is pulled away from the surface on which it is located, a vacuum is created in the suction cup and it is held to the surface. In this position, the bump is also pulled away from the surface. However, when the center of the suction cup is released and allowed to move toward the surface, the bump presses against the surface and causes the seal formed by the perimeter of the suction cup to the surface to be broken and the vacuum of the suction cup released.

It will be understood by persons skilled in the art that modifications can be made to the embodiments described herein while remaining within the scope of the claimed invention.

What is claimed is:

1. A telescoping rod, comprising:
a core tube having a first end and a second end;
a first pulley mounted inside the core tube at the first end;
a second pulley mounted inside the core tube at the second end;
a belt mounted around and between the first pulley and the second pulley;
a first arm coupled to the belt, partially located inside the core tube, and extending outward of the first end of the core tube; and
a second arm coupled to the belt, partially located inside the core tube, and extending outward of the second end of the core tube.

2. The telescoping rod of claim 1, wherein the belt contains teeth in an inside surface of the belt, the first pulley contains teeth that engage the teeth of the belt, and the second pulley contains teeth that engage the belt.

3. The telescoping rod of claim 1, further comprising a first clamp that couples the belt to the first arm and a second clamp that couples the belt to the second arm.

4. The telescoping rod of claim 1, further comprising a middle tube that contains the core tube, wherein the middle tube has a first end and a second end.

5. The telescoping rod of claim 4, further comprising a cable positioned between to core tube and the middle tube.

6. The telescoping rod of claim 4, further comprising a top tube that at least partially fits inside the middle tube, extends outward from the middle tube at the first end of the middle tube, and is coupled to the first arm.

7. The telescoping rod of claim 6, further comprising first bushing located on an outside surface of the top tube at the second end of the top tube.

8. The telescoping rod of claim 7, wherein the first bushing comprises two parts.

9. The telescoping rod of claim 7, wherein a middle portion of the first bushing has a larger diameter than another portion of the first bushing.

10. The telescoping rod of claim 6, further comprising a second bushing located at the first end of the middle tube between the top tube and the middle tube.

11. The telescoping rod of claim 10, wherein the second bushing includes at least one raised surface that presses on an inside surface of the middle tube and cause a portion of the second bushing to bend and apply pressure to an outside surface of the top tube.

12. The telescoping rod of claim 6, further comprising a top cap that couples the first arm and the top tube to a mirror.

13. The telescoping rod of claim 6, further comprising a bottom tube that at least partially extends over the middle tube, extends away from the middle tube at the second end of the middle tube, and is coupled to the second arm.

14. The telescoping rod of claim 13, further comprising a third bushing located at a first end of the bottom tube between the bottom tube and the middle tube.

15. The telescoping rod of claim 14, wherein the third bushing includes at least one raised surface that presses on an inside surface of the bottom tube and cause a portion of the third bushing to bend and apply pressure to an outside surface of the middle tube.

16. The telescoping rod of claim 13, further comprising a pad coupled to the middle tube that presses on the bottom tube to slow movement between the middle tube and the bottom tube.

17. The telescoping rod of claim 16, wherein the pad is longer in a first dimension along the axis of the middle tube than it is wide in a second dimension that is perpendicular to the first dimension.

18. The telescoping rod of claim 13, further comprising a bottom cap that couples the second arm and the bottom tube to a base.
